(19) United States
(12) Patent Application Publication
(10) Pub. No.: US 2018/0018572 A1
(43) Pub. Date: Jan. 18, 2018

(54) METHOD, APPARATUS, DEVICE, AND SYSTEM FOR PREDICTING FUTURE TRAVEL VOLUMES OF GEOGRAPHIC REGIONS BASED ON HISTORICAL TRANSPORTATION NETWORK DATA

(71) Applicant: Alibaba Group Holding Limited, Grand Cayman (KY)

(72) Inventors: Yu WANG, Hangzhou (CN); Rui WANG, Hangzhou (CN); Zhou YE, Hangzhou (CN); Jinming WANG, Hangzhou (CN)

(21) Appl. No.: 15/646,132

(22) Filed: Jul. 11, 2017

(30) Foreign Application Priority Data
Jul. 12, 2016 (CN) 201610545484.7

(51) Int. Cl. G06N 5/04

(52) U.S. Cl. CPC G06N 5/04

(57) ABSTRACT

The present application provides a method, apparatus, device, and system for predicting future travel volumes of geographic regions based on historical transportation network data. In one embodiment, the disclosure describes a method comprising receiving first historical travel data associated with a plurality of users, the first historical travel data including a plurality of first historical travel bookings for a plurality of regions of a map; predicting user travel information in a selected region of the plurality of regions in a future time range based on the first historical travel data, the user travel information including, within the future time range for the selected region, a future travel booking quantity and a future travel booking response quantity; and transmitting the user travel information to one of a service device or a user device.

### CROSS-REFERENCE TO RELATED APPLICATIONS

This application claims the benefit of priority of Chinese Application No. 201610545484.7, titled “Method, Apparatus, Equipment, and System for Obtaining Travel Data,” filed on Jul. 12, 2016, which is hereby incorporated by reference in its entirety.

### BACKGROUND

### Technical Field

The disclosure relates to Internet-based transportation technologies, and specifically, to methods, apparatuses, devices, and systems for predicting future travel volumes of geographic regions based on historical transportation network data.

### Description of the Related Art

With cities developing rapidly, larger cities are more becoming common. With the increase in the population size of cities, people's demands for traveling correspondingly increase. Online car-hailing services or car-pooling services, such as UBER and LYFT, are currently useful alternatives to taxis, private cars, public transportation, and other traditional means of transportation.

In current online car-hailing/car-pooling services, a user device of a traveling user generally initiates a travel request and sends it to a cloud server (e.g., via a mobile application and a network-connected processing system). The cloud server publishes the travel request on a service platform. A service device (e.g., a terminal device of a car owner who is capable of providing a travel service) responds to the user request received from the service platform and provides the travel service accordingly (e.g., transports the user). In current systems, the service platform provides a navigational guidance according to the geographic location and travel time of the user and the geographic location and idle time of the driver. The driver will then be able to respond to the travel request of the user according to the geographic locations of both sides.

However, with the continuous development of city streets and roads, traffic conditions have become increasingly complicated. Commonly, one region may have a high number of users requesting travel but a low number of drivers (or other entities) providing services. Conversely, another region might have a lower number of users requesting travel but a higher number of drivers (or other entities) providing services. As a result, travel services provided by current techniques struggle to meet users' travel demand or fulfill car owners' needs as drivers, resulting in low service efficiency.

Thus, in current systems, the number of users requesting travel services does not match the number of service devices (or providers) providing a service. Similarly, current systems are not able to fulfill car owners' needs in maximizing earnings and reducing idle times.

### BRIEF SUMMARY

To solve the aforementioned technical problems, the disclosure provides methods, apparatuses, devices, and systems for predicting future travel volumes of geographic regions based on historical transportation network data.

In one embodiment, the disclosure describes a method comprising receiving first historical travel data associated with a plurality of users, the first historical travel data including a plurality of first historical travel bookings for a plurality of regions of a map; predicting user travel information in a selected region of the plurality of regions in a future time range based on the first historical travel data, the user travel information including, within the future time range for the selected region, a future travel booking quantity and a future travel booking response quantity; and transmitting the user travel information to one of a service device or a user device.

In one embodiment, the disclosure describes an apparatus comprising a processor and a non-transitory memory storing computer-executable instructions therein that, when executed by the processor, cause the apparatus to perform the operations of: receiving first historical travel data associated with a plurality of users, the first historical travel data including a plurality of first historical travel bookings for a plurality of regions of a map; predicting user travel information in a selected region of the plurality of regions in a future time range based on the first historical travel data, the user travel information including, within the future time range for the selected region, a future travel booking quantity and a future travel booking response quantity; and transmitting the user travel information to one of a service device or a user device.

The disclosed embodiments make it possible to predict user travel information in at least one region of a map in a future time range according to first historical travel data in a preset travel database. The user travel information is pushed to at least one service device and/or at least one user device so that the service device can efficiently provide service to a user according to the user travel information. As a result, a travel request of the user device may be responded to in time. Such a mechanism ensures that a travel request of a user matches a service device providing a service, meeting the user's travel demands and fulfilling a car owner's needs, thereby greatly improving both the user and the car owner's service experience.

### BRIEF DESCRIPTION OF THE DRAWINGS

To more clearly illustrate the technical solutions in the disclosed embodiments, the drawings used in the description of the embodiments will be introduced briefly below. The drawings described below are only some embodiments, and those skilled in the art also can obtain other embodiments according to these drawings without undue or creative effort.

FIG. 1 is a diagram of a Geohash grid according to some embodiments of the disclosure.

FIG. 2 is an architectural diagram illustrating a travel service system according to some embodiments of the disclosure.

FIG. 3 is a flow diagram illustrating a method for predicting future travel volumes of geographic regions based on historical transportation network data according to some embodiments of the disclosure.

FIG. 4 is a flow diagram illustrating a method for predicting future travel volumes of geographic regions based on historical transportation network data according to some embodiments of the disclosure.

FIG. 5 is a flow diagram illustrating a method for predicting future travel volumes of geographic regions based on historical transportation network data according to some embodiments of the disclosure.

FIG. 6 is a flow diagram illustrating a method for predicting future travel volumes of geographic regions based on historical transportation network data according to some embodiments of the disclosure.

FIG. 7 is a flow diagram illustrating a method for predicting a total travel booking quantity and a total travel booking response quantity in each grid on a current date according to some embodiments of the disclosure.

FIG. 8 is a flow diagram illustrating a method for obtaining first change trends of historical travel booking quantities and second change trends of historical travel booking response quantities in each grid under different date attributes according to some embodiments of the disclosure.

FIG. 9 is a flow diagram illustrating a method for predicting future travel volumes of geographic regions based on historical transportation network data according to some embodiments of the disclosure.

FIG. 10 is a diagram of an interface according to some embodiments of the disclosure.

FIG. 11 is a diagram of an interface according to some embodiments of the disclosure.

FIG. 12 is a flow diagram illustrating a method for predicting future travel volumes of geographic regions based on historical transportation network data according to some embodiments of the disclosure.

FIG. 13 is a diagram of an interface according to some embodiments of the disclosure.

FIG. 14 is a flow diagram illustrating a method for predicting future travel volumes of geographic regions based on historical transportation network data according to some embodiments of the disclosure.

FIG. 15 is a diagram of an interface according to some embodiments of the disclosure.

FIG. 16 is a diagram of an interface according to some embodiments of the disclosure.

FIG. 17 is a diagram of an interface according to some embodiments of the disclosure.

FIG. 18 is a diagram of an interface according to some embodiments of the disclosure.

FIG. 19 is a flow diagram illustrating a method for predicting future travel volumes of geographic regions based on historical transportation network data according to some embodiments of the disclosure.

FIG. 20 is a flow diagram illustrating a method for predicting future travel volumes of geographic regions based on historical transportation network data according to some embodiments of the disclosure.

FIG. 21 is a diagram of an interface according to some embodiments of the disclosure.

FIG. 22 is a flow diagram illustrating a method for predicting future travel volumes of geographic regions based on historical transportation network data according to some embodiments of the disclosure.

FIG. 23 is a flow diagram illustrating a method for predicting future travel volumes of geographic regions based on historical transportation network data according to some embodiments of the disclosure.

FIG. 24 is a signaling flow diagram illustrating a method for predicting future travel volumes of geographic regions based on historical transportation network data according to some embodiments of the disclosure.

FIG. 25 is a diagram of an apparatus for predicting future travel volumes of geographic regions based on historical transportation network data according to some embodiments of the disclosure.

FIG. 26 is a diagram of an apparatus for predicting future travel volumes of geographic regions based on historical transportation network data according to some embodiments of the disclosure.

FIG. 27 is a diagram of an apparatus for predicting future travel volumes of geographic regions based on historical transportation network data according to some embodiments of the disclosure.

FIG. 28 is a diagram of an apparatus for predicting future travel volumes of geographic regions based on historical transportation network data according to some embodiments of the disclosure.

FIG. 29 is a diagram of an apparatus for predicting future travel volumes of geographic regions based on historical transportation network data according to some embodiments of the disclosure.

FIG. 30 is a diagram of an apparatus for predicting future travel volumes of geographic regions based on historical transportation network data according to some embodiments of the disclosure.

FIG. 31 is a diagram of an apparatus for predicting future travel volumes of geographic regions based on historical transportation network data according to some embodiments of the disclosure.

FIG. 32 is a diagram of an apparatus for predicting future travel volumes of geographic regions based on historical transportation network data according to some embodiments of the disclosure.

FIG. 33 is a diagram of an apparatus for predicting future travel volumes of geographic regions based on historical transportation network data according to some embodiments of the disclosure.

FIG. 34 is a diagram of an apparatus for predicting future travel volumes of geographic regions based on historical transportation network data according to some embodiments of the disclosure.

FIG. 35 is a diagram of a cloud server according to some embodiments of the disclosure.

FIG. 36 is a diagram of a user device according to some embodiments of the disclosure.

FIG. 37 is a diagram of a service device according to some embodiments of the disclosure.

FIG. 38 is a diagram of a system for predicting future travel volumes of geographic regions based on historical transportation network data according to some embodiments of the disclosure.

### DETAILED DESCRIPTION

Several embodiments will be described in detail here and examples thereof are shown in the drawings. The following description refers to the drawings in which the same numbers in different drawings represent the same or similar elements unless otherwise indicated. The embodiments described in the following description do not represent all possible embodiments consistent with the scope of the disclosure. Instead, they are merely examples consistent with some aspects of the disclosure. For clarity, definitions of specific terms or phrases used in the disclosure are described first when necessary.

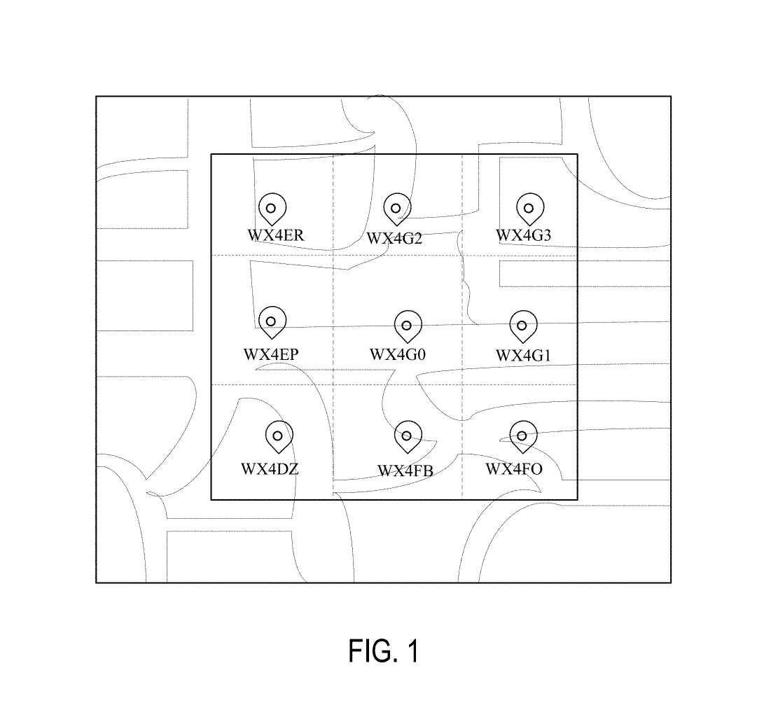

FIG. 1 is a diagram of a Geohash grid according to some embodiments of the disclosure.

In one embodiment, a Geohash represents the conversion of two-dimensional latitudes and longitudes into strings. For example, a basic map shown in FIG. 1 shows Geohash strings of nine regions in Beijing (e.g., “WX4ER,” “WX4G2,” “WX4G3,” etc.) and each string represents a rectangular region (referred to as a Geohash “grid”). That is to say, all points (e.g., latitude/longitude coordinates) in a given rectangular region share the same Geohash string. In this manner, privacy can be protected (only rough regional locations instead of specific points are shown) and buffering is enabled.

For example, users in the upper-left corner region may continuously send location information to request data regarding nearby restaurants. In this example, the Geohash strings of these users are all WX4ER, and the WX4ER string may be used as an index (e.g., key) to retrieve relevant data. Since a correspondence between Geohash grids and latitude and longitude coordinate ranges is stored in a map database, a key of each Geohash string has a corresponding value which can be buffered. The value may include different types of Point of Interest (“POI”) information. A map background process may obtain multiple values corresponding to the WX4ER string according to location requests of the users and then perform filtering according to attributes of POI information to obtain restaurant information in this region.

A method, apparatus, and device for predicting future travel volumes of geographic regions based on historical transportation network data involved in the embodiments can be applied to any system having a car-hailing service or a car-pooling service or a system providing other travel services to users.

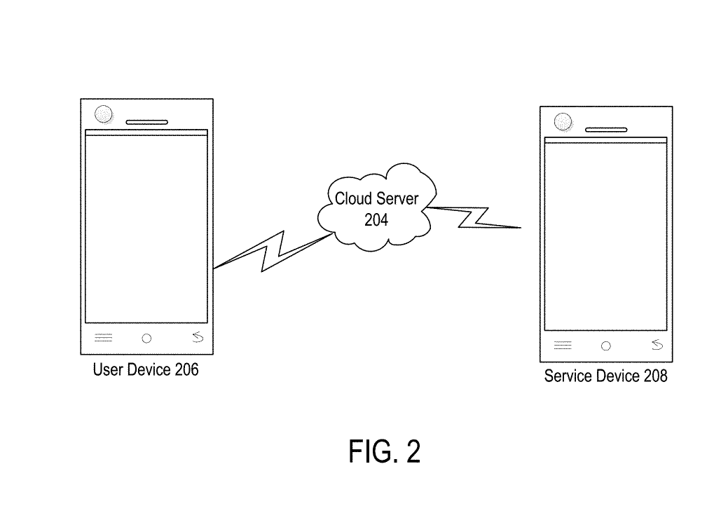

FIG. 2 is an architectural diagram illustrating a travel service system according to some embodiments of the disclosure.

As shown in FIG. 2, the system may include a cloud server 204, a user device 206, and a service device 208. The user device 206 is configured to initiate a travel request and send it to the cloud server 204. The cloud server 204 publishes the travel request on a service platform (not illustrated, but part of cloud server 204 in one embodiment). The service device 208 responds to the user request on the service platform and provides a travel service accordingly.

The service platform can be, for example, a travel service provider's computer and network infrastructure, such as that employed by such services such as DIDI DACHE, UBER, AMAP, or BAIDU MAP. In addition, in some embodiments, the cloud server 204 may predict a user's travel request during a certain time period on a certain day in the future according to historical travel data of the user. The cloud server 204 may then send predicted user travel information of the user in the future time to the user device 206 and/or service device 208. The user device 206 can then, according to the user travel information predicted by the cloud server 204, identify which regions have a higher number of travel requests at the current time and which regions have a lower number of travel requests. The user device 206 may also identify which regions have many service devices (and, by proxy, drivers) providing services. The user device 206 can determine, according to the user travel information, whether to send a current travel request to the cloud server 204, or when and where to send a travel request to the cloud server 204. In addition, the service device 208 (e.g., a device used by a driver) can also identify which regions have a higher number of travel requests at the current time and which regions have a lower number of travel requests according to the user travel information. The service device 208 (e.g., a human or autonomous operator of the service device 208) can then determine, according to the user travel information, which region it should move to at the current time to provide services to a user or when to provide services to a user. That is, some embodiments enable the service device 208 to provide convenient services to a user according to a predicted travel request, meeting a user's travel requests, solving the technical problem in current techniques that the number of users requesting travel does not match with the number of service devices providing a service and the problem of not being able to fulfill car owners' needs in earnings.

In one embodiment, the user device 206 may be a mobile phone, a tablet, a wearable device, a personal digital assistant (PDA), or the like. The service device 208 may be a mobile phone, tablet, PDA, onboard device on a means of transportation, a wearable device, or the like. The means of transportation may include, but is not limited to, vehicles such as automobiles or motorcycles having internal combustion engines, electric automobiles or motorcycles, electric bicycles, electric self-balancing scooters, and remote-control vehicles. The vehicle involved here may be a pure-oil vehicle, or a pure-gas vehicle, or an oil-and-gas-combined vehicle, or an electric vehicle. The type of the vehicle is not limited in the embodiments. In some embodiments, the onboard device may be a vehicle-mounted navigation system or a console.

Technical solutions of the disclosure are described in detail below with respect to specific embodiments. The following specific embodiments may be combined with one another. Details of the same or similar concepts or processes may not be given again in some embodiments.

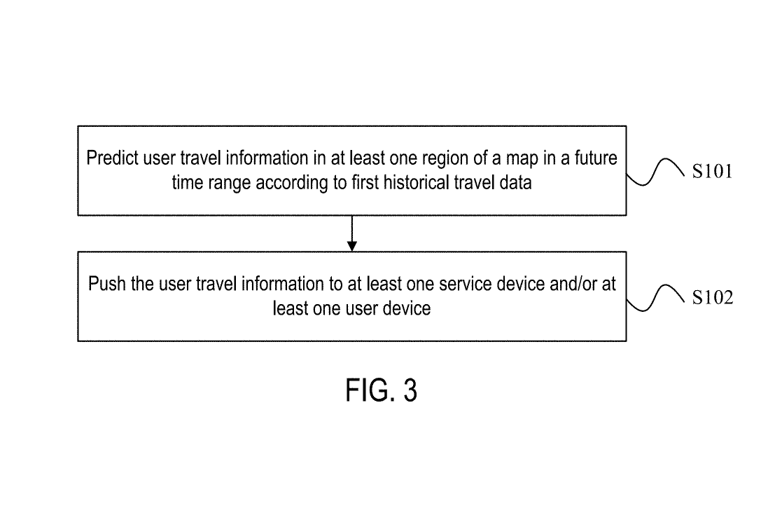

FIG. 3 is a flow diagram of a method for predicting future travel volumes of geographic regions based on historical transportation network data according to some embodiments of the disclosure.

In one embodiment, the illustrated method may be executed by an apparatus, the apparatus being implemented by software, hardware, or a combination of software and hardware. In an alternative embodiment, the apparatus may be integrated in a cloud server or in a core network device managing a cloud server, or may be an independent cloud server. In the illustrated embodiment, a cloud server is used as example of the operating device. The illustrated embodiment involves a process wherein the cloud server predicts a user's travel request in a future time range according to first historical travel data of the user in a travel database. The cloud server then sends the predicted travel request of the user to a service device, enabling the service device to provide a travel service to the user according to the predicted travel request of the user. As shown in FIG. 3, the method may include the following steps.

S101: Predict user travel information in at least one region of a map in a future time range according to first historical travel data.

In one embodiment, the first historical travel data represents historical travel booking information for different regions of the map, and the user travel information comprises a future travel booking quantity and a future travel booking response quantity in the region within the future time range.

In the illustrated embodiment, the following problems in current systems are avoided: the number of users requesting travel does not match with the number of service devices providing a service and car owners' needs in earnings is not satisfied. In some embodiments, the cloud server may record the first historical travel data of users in a travel database, the first historical travel data can be used to represent historical travel booking information in different regions of the map. In one embodiment, the historical travel booking information may include information such as user accounts, user names, pick-up points and destinations, and booking quantities. That is to say, the travel database includes historical travel booking information of all users. The cloud server may predict user travel information in at least one region of a map in a future time range according to the first historical travel data. The user travel information includes a future travel booking quantity and a future travel booking response quantity (namely, the quantity of future travel bookings responded to by service devices) in each region in the future time range. In one embodiment, the regions involved in some embodiments may be a Geohash grid obtained after Geohash processing is performed on basic geographic information of the map. Alternatively, the regions may be administrative regions or other regions on the map. In one embodiment, the future time range may be a current day, a certain time period in a current day, or a plurality of consecutive days in the future. The future time range is not intended to be limited in the disclosed embodiments.

For example, when the cloud server predicts user travel information in at least one region in the future time range, the cloud server may predict, according to historical travel booking information in a certain region on some workdays saved in the first historical travel data, user travel information in the region on a current workday. In one embodiment, the cloud server may build a model according to the first historical travel data, and then use the identifier of the predicted region and the next workday date as input of the model to obtain output of the model. In one embodiment, the output of the model is user travel information in the region on the current workday. In another example, the cloud server may further predict, according to a changing trend of bookings in a certain region within a period of time saved in the first historical travel data, user travel information in the region at a certain time in the future. Specific techniques of predicting user travel information in different regions within the future time range is not limited in the disclosed embodiments. Any technique will suffice as long as travel information of a user in the future can be predicted and provided to a service device as a reference for providing services to the user.

S102: Push the user travel information to at least one service device and/or at least one user device.

After the cloud server predicts the user travel information in at least one region in the future time range, the cloud server may send user travel information for some or all regions within the at least one region in the future time range to at least one service device and/or at least one user device. That is, the cloud server may broadcast the predicted user travel information. Alternatively, the cloud server may send, in a targeted manner, the predicted user travel information to a service device and/or user device querying the cloud server for the user travel information.

After receiving the user travel information, the service device can, according to the predicted user travel information, identify which region has a higher number of future travel requests and identify the number of future travel requests in the region already responded to. The service device can then decide whether to provide services to a user in the region. For example, the service device may, through the predicted user travel information in the at least one region within the future time range, identify that a future travel booking quantity in region A on Monday is 1000 and a future travel booking response quantity in region A exceeds 98% of the future travel booking quantity (e.g. 980), and that a future travel booking quantity in region B on Monday is 500 and a future travel booking response quantity in region B is 20% of the future travel booking quantity (e.g., 100). The service device can choose to go to region B according to the information to provide a travel service to a user. In this way, it can be ensured that a travel request of a user in region B is satisfied. Earnings of a car owner of the service device are also guaranteed, thereby greatly improving the service experience for both the user and the car owner.

After receiving the user travel information, the user device can, according to the predicted user travel information, identify which region has a higher number of future travel requests and identify the number of the of future fulfilled travel requests in the region so as to determine whether to initiate a travel request in the region. For example, the service device may, through the predicted user travel information in the at least one region within the future time range, identify that a future travel booking quantity in region A on Monday is 1000 and a future travel booking response quantity in region A exceeds 98% of the future travel booking quantity, and that a future travel booking quantity in region B on Monday is 500 and a future travel booking response quantity in region B is 20% of the future travel booking quantity. The user device can decide to initiate a travel request in region A so as to ensure that the initiated travel request can be responded to in time, thereby greatly improving experience for users who hail cars.

The method for predicting future travel volumes of geographic regions based on historical transportation network data provided in the previous embodiments predicts user travel information in at least one region of a map in a future time range according to first historical travel data in a preset travel database. The user travel information is pushed to at least one service device and/or at least one user device so that the service device is able to provide a service to a user according to the user travel information. As a result, a travel request of the user device may be responded to in time. Such a mechanism ensures that a travel request of a user matches a service device providing a service, meeting the user's travel demand and fulfilling a car owner's needs in earnings, thereby greatly improving both the user and the car owner's service experience.

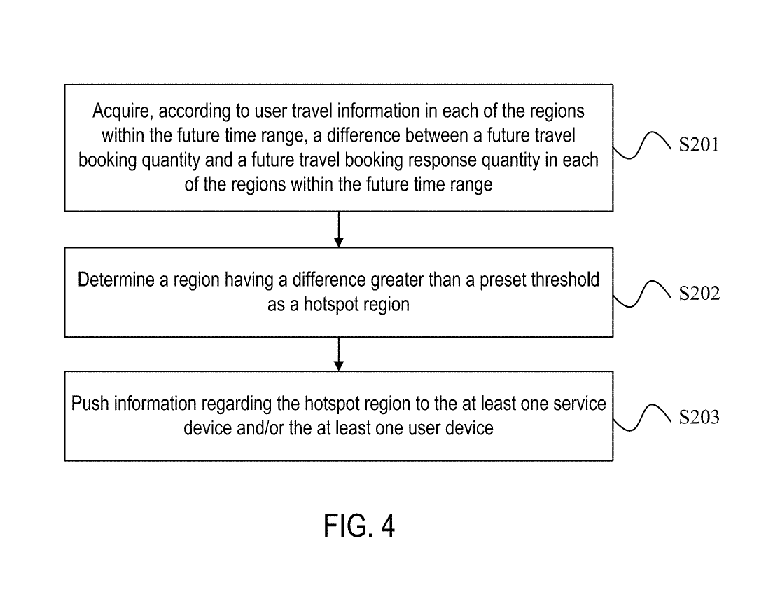

FIG. 4 is a flow diagram illustrating a method for predicting future travel volumes of geographic regions based on historical transportation network data according to some embodiments of the disclosure.

The illustrated embodiment involves a method wherein a cloud server pushes information of a hotspot region to at least one service device and/or at least one user device. The service device can then provide a service to a user in the hotspot region in an improved manner; and the user device can selectively initiate a travel request. Based on the aforementioned embodiment, the method may further include the following steps.

S201: Acquire, according to user travel information in each of the regions within the future time range, a difference between a future travel booking quantity and a future travel booking response quantity in each of the regions within the future time range.

Specifically, the difference between the future travel booking quantity and the future travel booking response quantity in each region in the future time range acquired by the cloud server may be a difference obtained by directly subtracting the future travel booking response quantity from the future travel booking quantity. Alternatively, the difference may be a weighted difference after subtraction. The difference algorithm here is determined by a preset threshold in the following step (S202). If the preset threshold in step S202 is a weighted threshold, the difference between the future travel booking quantity and the future travel booking response quantity is a weighted difference; and if the preset threshold in step S202 is an unweighted threshold, the difference between the future travel booking quantity and the future travel booking response quantity is a difference obtained by directly subtracting the future travel booking response quantity from the future travel booking quantity.

S202: Determine a region having a difference greater than a preset threshold as a hotspot region. In one embodiment, the hotspot region may be a region having many future travel bookings of users within the future time range. In another embodiment, there may be one hotspot region or multiple hotspot regions.

S203: Push information regarding the hotspot region to the at least one service device and/or the at least one user device.

In one embodiment, there may be one or multiple pieces of information regarding the hotspot region. The information regarding the hotspot region may be an identifier of the hotspot region, latitude and longitude coordinate information regarding the hotspot region, etc.

In one embodiment, the regions corresponding to the user travel information predicted by the cloud server may be grids obtained after discretization is performed on basic geographic location information of the map (described more fully herein). In one embodiment, the grids may be divided by using any method, as long as each grid corresponds to a latitude and longitude coordinate range in the map. In one embodiment, the grid may be a Geohash grid. In one embodiment, the information regarding the hotspot region is POI information in a Geohash grid having a difference greater than the preset threshold. Each Geohash grid corresponds to a latitude and longitude coordinate range on the map. That is to say, all geographic location information within a certain latitude and longitude coordinates range can be grouped into a Geohash grid that corresponds to the latitude and longitude coordinates range. The POI information may be restaurant information, building information, and so on. For ease of description, grids in the following embodiments are all described by using Geohash grids as an example.

After receiving information of a hotspot region sent by the cloud server, the service device can move to a geographic location indicated through the hotspot region information and provide a service to a user in the hotspot region. This not only better satisfies a user's travel request in the hotspot region, it also better guarantees earnings of a car owner. In addition, after receiving hotspot region information sent by the cloud server, the user device may choose to move to a geographic location indicated through the hotspot region information for a car-hailing service; or the user device may choose to avoid the hotspot region for the car-hailing service. In other words, the user device can autonomously choose the place for initiating a travel request according to user travel information and the hotspot region information, thereby greatly improving a user's experience in hailing a car.

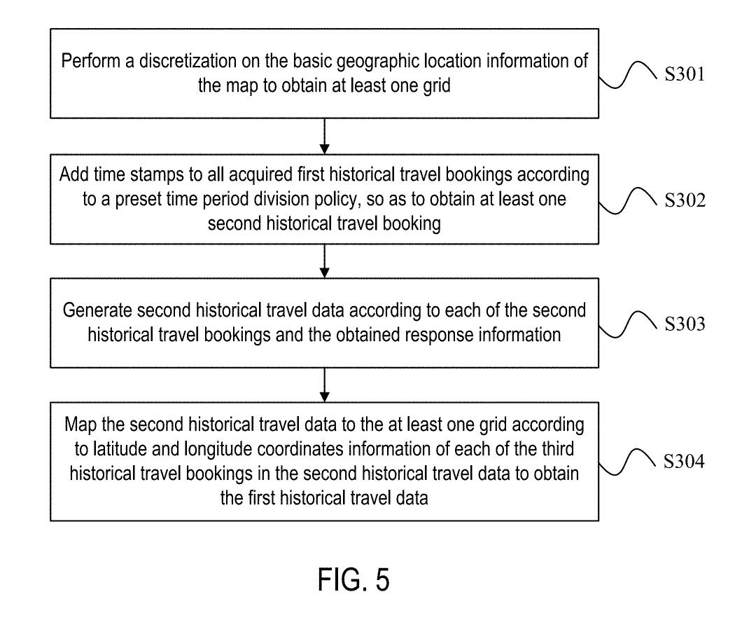

FIG. 5 is a flow diagram illustrating a method for predicting future travel volumes of geographic regions based on historical transportation network data according to some embodiments of the disclosure.

The embodiment illustrated in FIG. 5 involves a method wherein a cloud server builds a travel database for facilitating prediction of user travel information in the future. Based on the aforementioned embodiment, before step S101 discussed in connection with FIG. 3, the following steps may be performed.

S301: Perform a discretization process on the basic geographic location information of the map to obtain at least one grid.

Specifically, the map in this embodiment may be any form of a map and the basic geographic location information of the map may be a series of latitude and longitude coordinate information. Geohash grids are now used as an example. The cloud server may perform discretization on the basic geographic location information of the map using a Geohash procedure to obtain at least one Geohash grid, each Geohash grid corresponding to a latitude and longitude coordinates range and an identifier. In one embodiment, the identifier may be a Geohash string.

S302: Add time stamps to all acquired first historical travel bookings according to a preset time period division policy, so as to obtain at least one second historical travel booking.

The time stamp comprises a date when the first historical travel booking is scheduled and an identifier of a time period during which the first historical travel booking is scheduled. The first historical travel booking may also include latitude and longitude coordinate information corresponding to the first historical travel booking and the time when the first historical travel booking is scheduled.

In one embodiment, a travel booking database records first historical travel bookings of all users in all regions of the map. The cloud server may add a time stamp to each first historical travel booking in the travel booking database according to a preset time period division policy, so as to obtain at least one second historical travel booking. Each first historical travel booking includes latitude and longitude coordinate information corresponding to the first historical travel booking and the time when the first historical travel booking is scheduled. In one embodiment, the first historical travel booking further comprises a name of the user placing the first historical travel booking, and/or an address of the user placing the first historical travel booking. Therefore, each second historical travel booking mentioned above includes not only all information in the first historical travel booking, it also includes information of the time stamp. In one embodiment, the time period division policy may include the following: 24 hours of a day are divided into several time periods according to a corresponding time length. For example, 24 hours of a day may be divided into 48 time periods if half an hour is used as the dimension. Each of the time periods are arranged chronologically; e.g., 0:00 to 0:30 is the first time period and 23:30 to 24:00 is the 48th time period. Other methods of dividing time periods may be utilized and the aforementioned example is not intended to limit by the scope of the disclosure.

In one embodiment, each first historical travel booking may further carry a booking identifier. A second historical travel booking, obtained after the cloud server adds a time stamp to the first historical travel booking, has the same booking identifier as that of the first historical travel booking. In one embodiment, the booking identifier may be a booking number.

For example, if a first historical travel booking is “15***001 User A Alibaba Xixi Campus X degrees north latitude Y degrees east longitude 2015-10-8-21:18:10”, then “15***001” is a number or identifier of the first historical travel booking; “User A” is a name of the user placing the first historical travel booking; “Alibaba Xixi Campus” is an address of the location where the first historical travel booking is scheduled, “X degrees north latitude Y degrees east longitude” is information of the latitude and longitude coordinate of the location when the first historical travel booking is scheduled; and “2015-10-8-21:18:10” is the time when the first historical travel booking is scheduled. According to this example, a second historical travel booking obtained after a time stamp is added may be “15***001 User A Alibaba Xixi Campus X degrees north latitude Y degrees east longitude 2015-10-8-21:18:10 2015-10-8 43”; “2015-10-8” is the date when the first historical travel booking is scheduled; and “43” is the identifier of the time period during which the first historical travel booking is scheduled. Based on this, the cloud server can learn how many second historical travel bookings exist during each time period of each historical date.

S303: Generate second historical travel data according to each of the second historical travel bookings and the obtained response information.

The second historical travel data comprises at least one third historical travel booking, each third historical travel booking comprises the second historical travel booking and a response state of the second historical travel booking. In one embodiment, the response information is used to indicate the response state for each of the second historical travel bookings.

Specifically, a response database records response information for each second historical travel booking. The response information can represent a response state of the second historical travel booking, i.e., representing whether the second historical travel booking is responded to by a service device and any specific information when the second historical travel booking is being responded to by the service device. An example is whether a driver accepts the booking and the specific information when the booking is accepted. Therefore, the cloud server may generate second historical travel data according to each second historical travel booking mentioned above and the obtained response information from the response database. The second historical travel data comprises at least one third historical travel booking, each third historical travel booking comprises the second historical travel booking; each third historical travel booking comprises a second historical travel booking and the response state of the second historical travel booking. In one embodiment, the response information may include a name of a driver responding to the second historical travel booking, latitude and longitude coordinate information of a service device when responding to the second historical travel booking, and a time when responding to the second historical travel booking takes place. In one embodiment, the response information may further include a booking identifier of the second historical travel booking.

For example, assuming the second historical travel booking in step S302 above has the following response information: “15***001 Driver X, M degrees north latitude, N degrees east longitude, 2015-10-8-21:19:00”. “15***001” is a booking identifier of the second historical travel booking; “Driver X” is the name of the driver responding to the second historical travel booking; “M degrees north latitude, N degrees east longitude” is the latitude and longitude coordinate information of a service device when responding to the second historical travel booking; and “2015-10-8-21:19:00” is the time when the second historical travel booking is being responded. Then, the cloud server can obtain a third historical travel booking according to the second historical booking in the example of step S302 and the response information. The third historical travel booking may be “15***001 User A Alibaba Xixi Campus, X degrees north latitude, Y degrees east longitude, 2015-10-8-21:18:10 2015-10-8 43, Yes Driver A M degrees north latitude, N degrees east longitude, 2015-10-8-21:19:00 2015-10-8 43”, wherein “15***001 User A Alibaba Xixi Campus, X degrees north latitude, Y degrees east longitude, 2015-10-8-21:18:10 2015-10-8 43” is the second historical travel booking, and “Yes Driver A M degrees north latitude N degrees east longitude 2015-10-8-21:19:00 2015-10-8 43” is the specific information when the second historical booking is being responded. That is, the specific information is the response state of the second historical travel booking.

In the same manner, the cloud server can obtain third historical travel bookings corresponding to other second historical travel bookings; multiple third historical travel bookings become the information used to form the second historical travel data.

S304: Map the second historical travel data to the at least one grid according to latitude and longitude coordinate information of each of the third historical travel bookings in the second historical travel data to obtain the first historical travel data.

Specifically, after the cloud server obtains the second historical travel data, the cloud server can determine a Geohash string corresponding to the latitude and longitude coordinate information of each third historical travel booking in the second historical travel data. This enables the cloud server to map each third historical travel booking in the second historical travel data to the at least one Geohash grid determined in step S301. Historical travel bookings corresponding to each Geohash grid will then be obtained and a travel database is then built. The travel database includes first historical travel data, which represents historical travel booking information for different Geohash grids on the map.

In one embodiment, the first historical travel data may specifically include a historical travel booking quantity and a historical travel booking response quantity in each grid during each time period on each historical date. The historical travel booking quantity here refers to the total quantity of second historical travel bookings in all the third historical travel bookings in the grid during each time period on each historical date. The historical travel booking response quantity refers to the total response quantity of all third historical travel bookings in the grid during each time period on each historical date. Accordingly, the predicted user travel information may specifically include a future travel booking quantity and a future travel booking response quantity in each grid during each time period on a future date. In one embodiment, the first historical travel data may further include a response waiting time to historical travel bookings in each grid during each time period on each historical date; the response waiting time may be at least one of the average response waiting time, a maximum response waiting time, a median response waiting time, and a minimum response waiting time for the historical travel bookings in each of the grids during each time period on each historical date.

In one embodiment, the latitude and longitude coordinate information of the third historical travel booking may include the latitude and longitude coordinate information corresponding to a second historical travel booking and the latitude and longitude coordinate information of a service device when it responds to the second historical travel booking comprised in response information corresponding to the second historical travel booking. When a Geohash string corresponding to the latitude and longitude coordinate information, which corresponds to the second historical travel booking, is the same as the Geohash string corresponding to the latitude and longitude coordinate information in the response information, it is then determined that only one Geohash string corresponding to the third historical travel booking exists. On the other hand, when the Geohash string corresponding to the latitude and longitude coordinate information, which corresponds to the second historical travel booking, is different from the Geohash string corresponding to the latitude and longitude coordinate information in the response information, it is then determined that two Geohash strings corresponding to the third historical travel booking exist. In this way, the mapping of the second historical travel data to the at least one Geohash grid mentioned above may be:

1) mapping the latitude and longitude coordinate information corresponding to a second historical travel booking in a third historical travel booking to the corresponding Geohash grid according to a corresponding Geohash string thereof;

2) mapping the latitude and longitude coordinate information of the response information that corresponds to a second historical travel booking in a third historical travel booking to the corresponding Geohash grid according to a corresponding Geohash string thereof.

Two final mapping results are as follows. In the first situation, the Geohash grid to which the second historical travel booking is mapped (namely, a Geohash grid where a traveler is located) and the Geohash grid to which the response information is mapped (namely, a Geohash grid where a driver is located) are the same Geohash grid; that is, the traveler and the driver are located in the same Geohash grid. In the second situation, the Geohash grid to which the second historical travel booking is mapped and the Geohash grid to which the response information is mapped are different; that is, the traveler and the driver are located in different Geohash grids.

When the traveler and the driver are located in the same Geohash grid, the first historical travel data may include a historical travel booking quantity and a historical travel booking response quantity in each Geohash grid during each time period on each historical date. In one embodiment, the first historical travel data may further include a response waiting time to historical travel bookings in each Geohash grid during each time period on each historical date. In one embodiment, the specific format of the first historical travel data may be “a sequence number of a Geohash grid+a historical date+an identifier of a time period on the historical date+a historical travel booking quantity+a historical travel booking response quantity (namely, the number of bookings that are responded to)+an average waiting time+a maximum waiting time+a median waiting time+a minimum waiting time”.

When the traveler and the driver are not in the same Geohash grid, the first historical travel data may include a historical travel booking quantity, a historical travel booking response quantity, and the booking quantity responded to by the service device in the Geohash grid that the historical travel bookings belongs to in each Geohash grid during each time period on each historical date. In one embodiment, the first historical travel data may further include a response waiting time for historical travel bookings in each Geohash grid during each time period on each historical date. In in this case, the specific format of the first historical travel data may be “a sequence number of a Geohash grid+a historical date+an identifier of a time period on the historical date+a historical travel booking quantity+a historical travel booking response quantity (namely, the number of bookings that are responded to)+an average waiting time+a maximum waiting time+a median waiting time+a minimum waiting time”+the booking quantity responded to by the service device in the Geohash grid that the historical travel bookings belongs to”. For example, assuming that a Geohash grid where historical travel bookings taking place is A; a historical travel booking quantity is 100; a historical travel booking response quantity is also 100; but the booking quantity responded to by service devices in the current Geohash grid that the historical travel bookings belong to is 90. This means the remaining 10 historical travel bookings are responded to by service devices in other Geohash grids.

In view of the above, no matter whether a traveler and a driver are in the same Geohash grid, the first historical travel data in the travel database represents a historical travel booking quantity and a historical travel booking response quantity in each Geohash grid during each time period on each historical date. It is then convenient for the cloud server to predict a future travel booking quantity and a future travel booking response quantity in each Geohash grid during each time period on a future date according to information provided by the first historical travel data, thereby greatly improving the accuracy of predicting travel requests.

The method for predicting future travel volumes of geographic regions based on historical transportation network data provided in this embodiment obtains at least one grid by performing a discretization process on the basic geographic location information of the map; add time stamps to all the first historical travel bookings acquired from a travel booking database according to a preset time period division policy to obtain at least one second historical travel booking; generate second historical travel data according to each of the second historical travel bookings and the response information acquired from a response database; map the second historical travel data to the at least one grid according to latitude and longitude coordinate information of each of the third historical travel bookings in the second historical travel data to obtain the first historical travel data. The cloud server will then be able to obtain, according to the first historical travel data, a historical travel booking quantity and a historical travel booking response quantity in each of the grids during each time period on each historical date. This then enables the cloud server to predict, according to the information provided from the first historical data, a future travel booking quantity and a future travel booking response quantity in the grid during each time period on a future date. In other words, this method greatly improves the prediction accuracy of users' traveling demand.

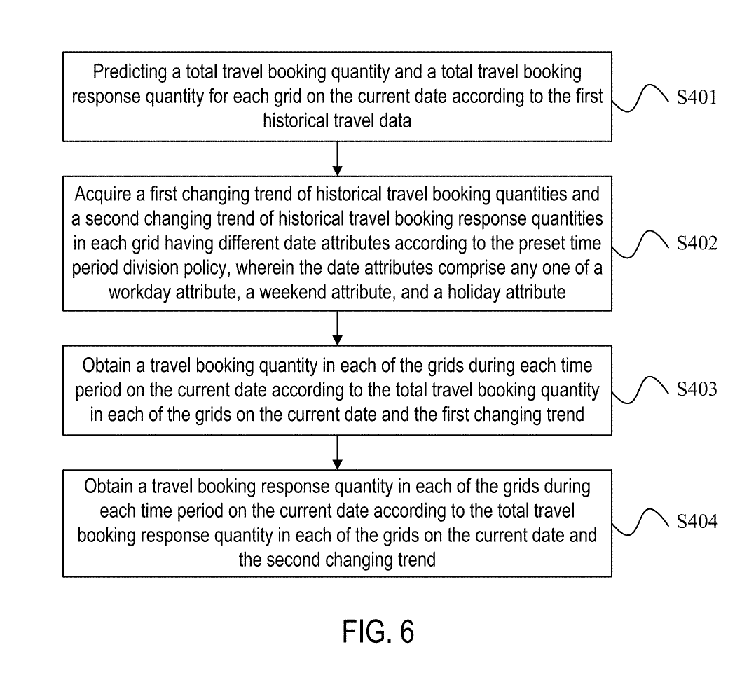

FIG. 6 is a flow diagram illustrating a method for predicting future travel volumes of geographic regions based on historical transportation network data according to some embodiments of the disclosure.

This embodiment involves a specific process in that a cloud server predicts user travel information in at least one region of a map in a future time range according to first historical travel data. The “future time range” in this embodiment may include a current date. In other words, the cloud server may predict user travel information on a current day according to first historical travel data. Based on the aforementioned embodiment, step S101 discussed above may specifically include the following steps.

S401: Predict a total travel booking quantity and a total travel booking response quantity for each grid on the current date according to the first historical travel data.

Specifically, still using Geohash grids as an example, the cloud server may predict the total travel booking quantity and the total travel booking response quantity in each Geohash grid on the current date through continuous changing trends of historical travel booking quantities and historical travel booking response quantities in each Geohash grid in the first historical travel data. Alternatively, the cloud server may train a corresponding model through a corresponding modeling algorithm using each historical date of a current grid as input, and a historical travel booking quantity and a historical travel booking response quantity on each historical date as output; and then use the current date as input, and the obtained output is the total travel booking quantity and the travel booking response quantity on the current date.

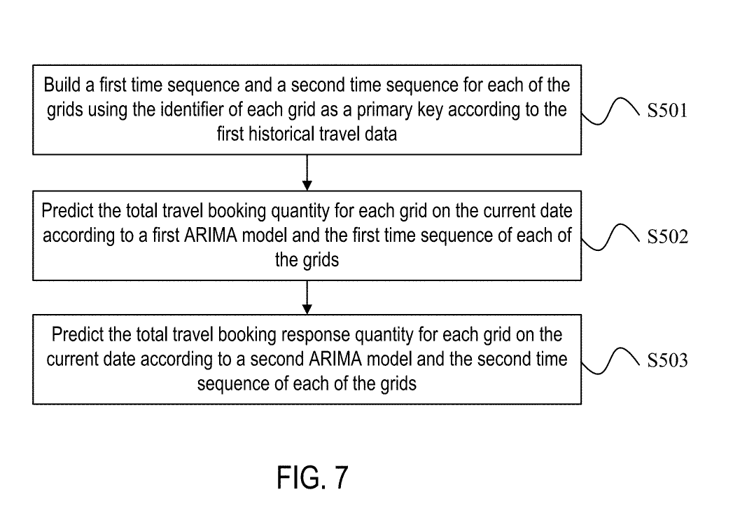

In one embodiment, references of the aforementioned method for predicting the total travel booking quantity and the total travel booking response quantity in each grid on the current date may be made by referring to the flow diagram shown in FIG. 7. That is, another embodiment of the disclosure provides a method for predicting the total travel booking quantity and the total travel booking response quantity in each grid on the current date including the following steps.

S501: Build a first time sequence and a second time sequence for each of the grids using the identifier of each grid as a primary key according to the first historical travel data.

The first time sequence comprises a total historical travel booking quantity in the grid on each historical date, the second time sequence comprises a total historical travel booking response quantity in the grid on each historical date, and lengths of the first time sequence and the second time sequence are equal to the number of the historical dates in the grid.

Specifically, still using Geohash grids as an example, each Geohash grid has a corresponding historical travel booking quantity on each historical date. A first time sequence and a second time sequence of each Geohash grid may be acquired using an identifier of each Geohash grid as a primary key and a corresponding historical travel booking quantity in the Geohash grid under each historical date as a value. Description is made by using one Geohash grid as an example below. A first time sequence of the Geohash grid includes a total historical travel booking quantity in the Geohash grid corresponding to each historical date. A length of the first time sequence is equal to the number of the historical dates in the Geohash grid. The second time sequence of the Geohash grid includes a total historical travel booking response quantity in the Geohash grid on each historical date. A length of the second time sequence is equal to the number of the historical dates in the Geohash grid.

For example, assuming that a first historical travel database includes a historical travel booking quantity and a historical travel booking response quantity in a Geohash grid A during each time period on each historical date, from January 1 to January 30; then a first time sequence of the Geohash grid A includes a historical travel booking quantity on each day, from January 1 to January 30 (namely, a sum of historical travel booking quantities in all time periods on one day); and a second time sequence includes a total historical travel booking response quantity on each day, from January 1 to January 30 (namely, a sum of historical travel booking response quantities in all time periods on one day).

S502: Predict the total travel booking quantity for each grid on the current date according to a first autoregressive integrated moving average (ARIMA) model and the first time sequence of each of the grids.

S503: Predict the total travel booking response quantity for each grid on the current date according to a second ARIMA model and the second time sequence of each of the grids.

Specifically, the first ARIMA model is a model built for travel bookings and therefore, a prediction may be performed through the first time sequence of each Geohash grid in combination with the first ARIMA model; the total travel booking quantity in each Geohash grid on the current date is then obtained. Likewise, the second ARIMA model is a model built for a travel booking response quantity; and therefore, a prediction may be performed through the second time sequence of each Geohash grid in combination with the second ARIMA model; the total travel booking response quantity in each Geohash grid on the current date is then obtained.

In view of the above, the cloud server obtains the total travel booking quantity and the total travel booking response quantity for each grid on the current date; step S402 is then performed. In one embodiment, the execution sequence of steps S502 and S503 is not limited to this embodiment, and comparable modeling algorithms may be utilized that fall within the scope of the disclosure.

S402: Acquire a first changing trend of historical travel booking quantities and a second changing trend of historical travel booking response quantities in each grid having different date attributes according to the preset time period division policy, wherein the date attributes comprise any one of a workday attribute, a weekend attribute, and a holiday attribute.

Specifically, still using Geohash grids as an example, a date attribute of the historical dates included in each Geohash grid may include any one of a workday attribute, a weekend attribute, and a holiday attribute, wherein the holiday can be a legal holiday such as New Year's Day, the Spring Festival, and Labor Day, except weekends including such holidays. Therefore, using the workday attribute as an example, the cloud server may obtain a first changing trend according to historical travel booking quantities in a certain Geohash grid on all the historical workdays; and the cloud server may obtain a second changing trend according to historical travel booking response quantities in the Geohash grid on all historical workdays. The first changing trend and the second changing trend use dates and time periods as dimensions, wherein the time periods are divided according to the time period division policy. That is, the first changing trend indicates the tendency of the historical travel booking quantities in different time periods on different workdays whereas the second changing trend indicates the tendency of the historical travel booking response quantities in different time periods on different workdays. In a similar manner, a first changing trend of historical travel booking quantities and a second changing trend of historical travel booking response quantities in each Geohash grid on a weekend attribute may be obtained; likewise, a first changing trend of historical travel booking quantities and a second changing trend of historical travel booking response quantities in each Geohash grid on a holiday attribute may be obtained.

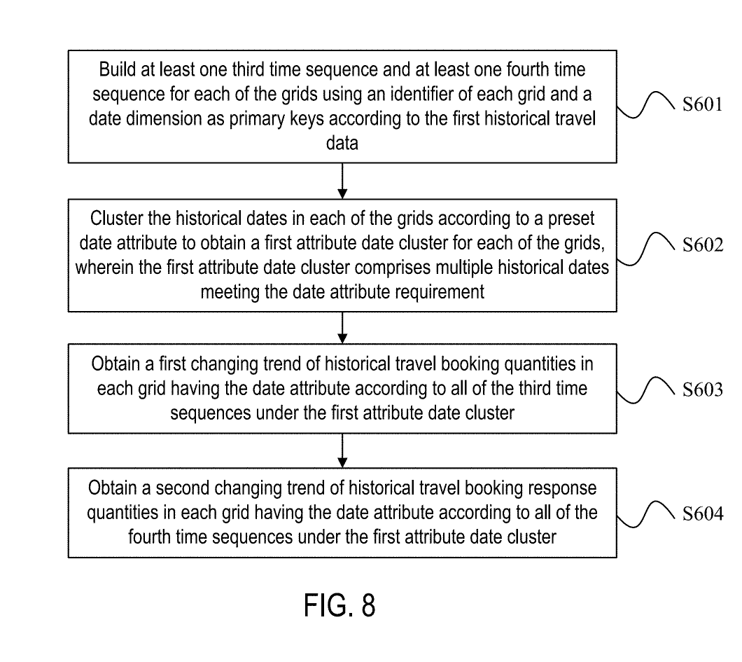

In one embodiment, references of the aforementioned method in obtaining first changing trend of historical travel booking quantities and second changing trend of historical travel booking response quantities in each grid on different date attributes may be made by referring to the flow diagram shown in FIG. 8. That is, another embodiment provides a method for obtaining first changing trends of historical travel booking quantities and second changing trends of historical travel booking response quantities in each grid one different date attributes. Still using Geohash grids as an example, the method specifically comprises the following steps.

S601: Build at least one third time sequence and at least one fourth time sequence for each of the grids using an identifier of each grid and a date dimension as primary keys according to the first historical travel data.

The third time sequence comprises historical travel booking quantities during different time periods on a historical date; and the fourth time sequence comprises historical travel booking response quantities during different time periods on the historical date.

Specifically, each Geohash grid has a corresponding historical travel booking quantity during each time period of each historical date; and then at least one third time sequence and at least one fourth time sequence of each Geohash grid may be acquired using an identifier of each Geohash grid and a date dimension as primary keys and a corresponding historical travel booking quantity in the Geohash grid during each time period on each historical date as a value. That is to say, for one Geohash grid, one historical date corresponds to one third time sequence and one fourth time sequence; the third time sequence includes historical travel booking quantities during multiple time periods on the historical date; a length of the third time sequence is equal to the number of the divided time periods; the fourth time sequence includes historical travel booking response quantities during multiple time periods on the historical date, and a length of the fourth time sequence is equal to the number of the divided time periods.

The previous division policy of dividing one day into 48 time periods is used as an example. Assuming the first historical travel database includes the historical travel booking quantity and the historical travel booking response quantity in the Geohash grid A during each time period on each historical date, from January 1 to January 30; then the Geohash grid A may include 30 third time sequences and 30 fourth time sequences; that is, each historical date corresponds to one third time sequence and one fourth time sequence. Using January 1 as an example, a third time sequence on January 1 includes: a historical travel booking quantity in a time period of 0:00 to 0:30; a historical travel booking quantity in a time period of 0:30 to 1:00; . . . and a historical travel booking quantity in a time period of 23:30 to 24:00. In other words, the third time sequence includes respective historical travel booking quantities in the 48 time periods. Accordingly, the fourth time sequence includes respective historical travel booking response quantities in the 48 time periods.

S602: Cluster the historical dates in each of the grids according to a preset date attribute to obtain a first attribute date cluster for each of the grids, wherein the first attribute date cluster comprises multiple historical dates meeting the date attribute requirement.

Specifically, assuming that the current date attribute preset by the cloud server is a workday attribute; then the cloud server may cluster historical dates in each Geohash grid to obtain a workday cluster (namely, the first attribute date cluster) in each of the Geohash grids; the workday cluster may include multiple historical dates (namely, historical workdays) satisfying the work date attribute. In one embodiment, still using the previous case as an example: first historical travel database includes the historical travel booking quantity and the historical travel booking response quantity in the Geohash grid A during each time period on each historical date, from January 1 to January 30. The clustering here may be: the cloud server selects a workday; compares a changing trend of historical travel booking quantities on that workday with a changing trend of historical travel booking quantities on each workday in the 30 days; and groups workdays having changing trend similarities greater than a preset similarity threshold into one cluster to obtain a workday cluster (namely, the first attribute date cluster) in the Geohash grid A. Using the same method, a weekend cluster and a holiday cluster in the Geohash grid A can be obtained. In a similar way, the first attribute date cluster in each Geohash grid is obtained.

S603: Obtain a first changing trend of historical travel booking quantities in each grid having the date attribute according to all of the third time sequences under the first attribute date cluster.

Specifically, still using the first attribute date cluster being a workday cluster as an example; when the cloud server obtains the workday cluster in the Geohash grid A, the cloud server may perform an average calculation on all the historical travel booking quantities in first time periods of the third time sequences under the workday cluster in the Geohash grid A to obtain an average booking quantity in the first time periods; and then another average calculation is performed on all the historical travel booking quantities in second time periods of the third time sequences to obtain an average booking quantity in the second time periods. The same method continues till the average booking quantities in 48 time periods are obtained. They are sorted based on their respective time periods and a first changing trend of historical travel booking quantities in the Geohash grid A under the workday attribute is obtained. When the preset date attribute is weekend and holiday, in this manner, a first changing trend of historical travel booking quantities under the weekend attribute and a first changing trend of historical travel booking quantities under the holiday attribute in the Geohash grid A can be obtained respectively.

S604: Obtain a second changing trend of historical travel booking response quantities in each grid having the date attribute according to all of the fourth time sequences under the first attribute date cluster.

Specifically, still using the first attribute date cluster being a workday cluster as an example; when the cloud server obtains the workday cluster in the Geohash grid A, the cloud server may perform an average calculation on all the historical travel booking response quantities in first time periods of the fourth time sequences under the workday cluster in the Geohash grid A to obtain an average booking response quantity in the first time periods; and then another average calculation is performed on all the historical travel booking response quantities in second time periods of the fourth time sequences to obtain an average booking response quantity in the second time periods. The same method continues till the average booking response quantities in 48 time periods are obtained. They are sorted based on their respective time periods and a second changing trend of historical travel booking quantities in the Geohash grid A under the workday attribute is obtained. In this manner, a second changing trend of historical travel booking response quantities under the weekend attribute and a second changing trend of historical travel booking response quantities under the holiday attribute in the Geohash grid A can be obtained respectively.

In view of the above, by using the method in the previous S602 to S604, first changing trends of historical travel booking quantities and second changing trends of historical travel booking response quantities in each Geohash grid under different date attributes can be obtained; and then S403 and S404 are performed. In one embodiment, the execution sequence of S603 and S604 is not limited by this embodiment.

S403: Obtain a travel booking quantity in each of the grids during each time period on the current date according to the total travel booking quantity in each of the grids on the current date and the first changing trend.

S404: Obtain a travel booking response quantity in each of the grids during each time period on the current date according to the total travel booking response quantity in each of the grids on the current date and the second changing trend.

Specifically, the cloud server has predicted the total travel booking quantity in each Geohash grid on the current date in the previous step of S401; therefore, the cloud server may choose, according to the first changing trends under different date attributes obtained in S603, a first changing trend with the same attribute as that of the current date. A travel booking quantity in each Geohash grid during each time period on the current date may be obtained according to the first changing trend. Similarly, the cloud server may choose, according to the second changing trends under different date attributes obtained in step S604, a second changing trend with the same attribute as that of the current date. A travel booking quantity in each Geohash grid during each time period on the current date may be obtained according to the second changing trend.

In one embodiment, the execution sequence of steps S403 and S404 is not limited by this embodiment of the disclosure.

In the method for predicting future travel volumes of geographic regions based on historical transportation network data provided in this embodiment, travel booking quantities and travel booking response quantities for different grids on a current date are predicted according to the first historical travel data to provide a service reference to a service device, thereby matching a travel requirement of a user with services provided by a service device. Not only the travel requirement of the user is satisfied, a car owner's earnings may also be guaranteed, greatly enhancing the service experience for both the user and the car owner.

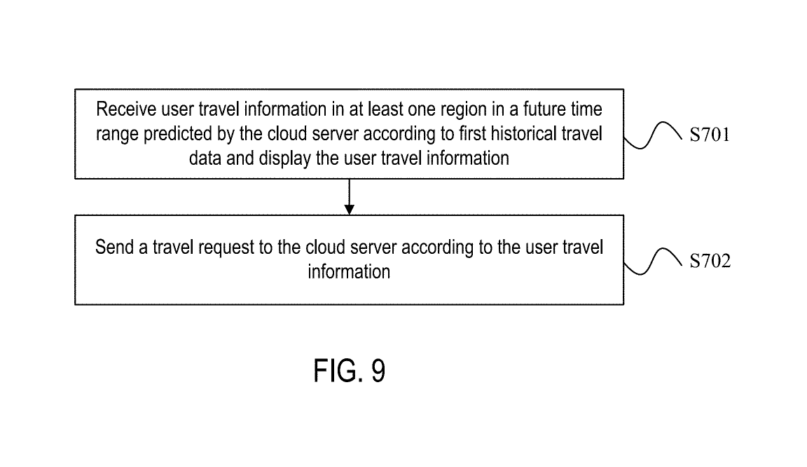

FIG. 9 is a flow diagram illustrating a method for predicting future travel volumes of geographic regions based on historical transportation network data according to some embodiments of the disclosure.

The illustrated embodiment describes a specific process in which a user device acquires user travel information in a future time range so as to obtain a car-hailing service according to the user travel information. As shown in FIG. 9, the method includes the following steps.

S701: Receive user travel information in at least one region in a future time range predicted by the cloud server according to first historical travel data and display the user travel information.

The first historical travel data represents historical travel booking information for different regions of the map, and the user travel information comprises a future travel booking quantity and a future travel booking response quantity in the region within the future time range.

S702: Send a travel request to the cloud server according to the user travel information.

Specifically, details regarding how the cloud server predicts user travel information in at least one region in a future time range according to first historical travel data can be made by referring to the embodiments discussed previously and details will not be repeated herein. After the cloud server acquires user travel information in at least one region in a future time range, the cloud server sends the user travel information to a user device and the user device displays the information, so that a user can view the user travel information through an interface of the user device. In one embodiment, the user device may display the predicted user travel information by pages or by items; or may display the predicted user travel information through images or animation; the animation display may be accompanied by corresponding voice instructions. The user travel information includes a future travel booking quantity and a future travel booking response quantity (namely, the quantity of future travel bookings responded to by service devices) in each region in the future time range. In one embodiment, the regions involved in this embodiment may be a Geohash grid obtained after Geohash processing is performed on basic geographic information of the map; or they may be administrative regions or other regions on the map. In one embodiment, the future time range may be a current day, a certain time period on a current day, or a few consecutive days in the future. The future time range is not limited in this embodiment.

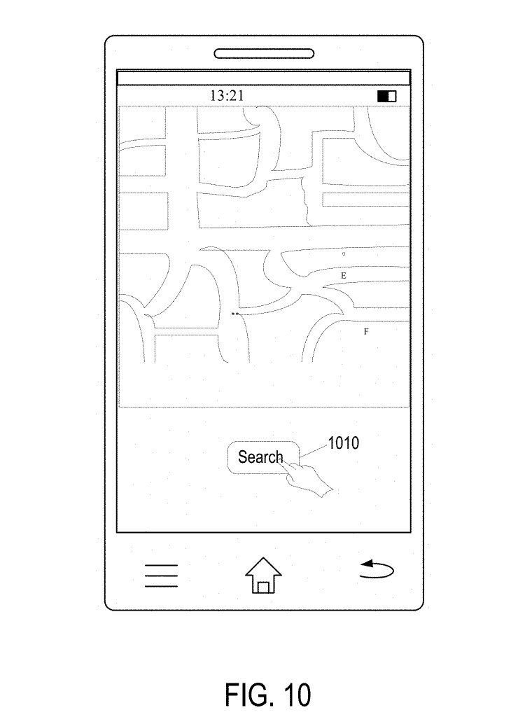

After the user learns about user travel information in at least one region in the future time range, the user selectively sends a travel request to the cloud server according to the user travel information. The user then may, for example, avoid busy hours or avoid regions with fewer responding vehicles. In one embodiment, as illustrated in FIG. 10, the user device may deploy a virtual control 1010 on an interface displaying the predicted user travel information; a travel request of the user to the cloud server can be sent once clicking the virtual control 1010 (as illustrated in FIG. 10). The cloud server will then publish the travel request on a service platform and a service device responds to the user request on the service platform and provides a travel service accordingly.

In the method for predicting future travel volumes of geographic regions based on historical transportation network data provided in this embodiment, user travel information in at least one region in a future time range sent by a cloud server is received and pushed to a user. The user then selectively sends a travel request to the cloud server through a user device; in this way, the user can avoid situations where the user may have to hail a car during peak hours or hail a car in regions with few responding vehicles, thereby greatly improving the timely response rate for car-hailing, thereby matching a travel requirement of a user with services provided by a service device. Not only the travel requirement of the user is satisfied, a user's experience in this regard is also greatly enhanced.

In one embodiment, the user travel information may be pushed to the user device by the cloud server proactively; or the user device may send an acquisition request carrying a future time range (namely, a predicted time period) to the cloud server to query user travel information in at least one region of the map in the future time range. The disclosure does not impose any limitation in this regard. In one embodiment, the acquisition request may further include a geographic location and then step S701 may include: receiving the user travel information, predicted by the cloud server according to the first historical travel data that corresponds to the geographic location.

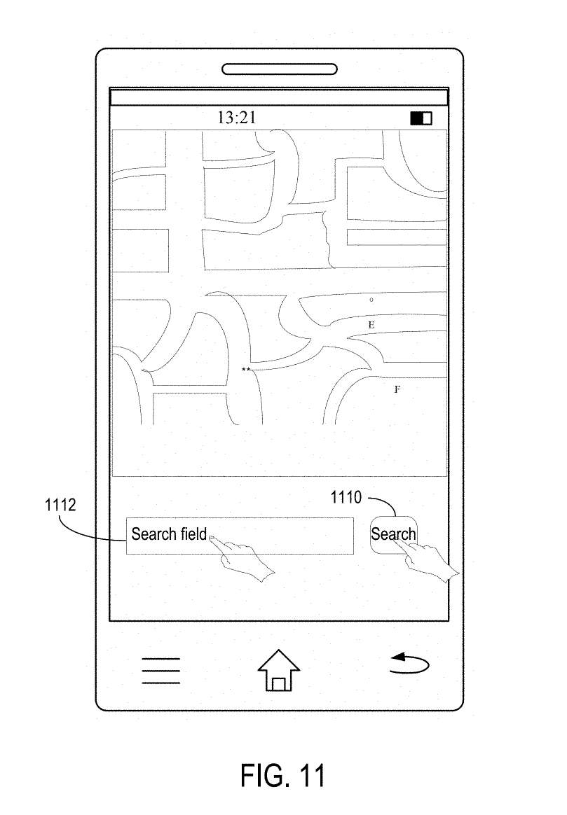

That is to say, when the user needs to query user travel information at a certain geographic location in a future time range, the user may send an acquisition request to the cloud server through the user device. The acquisition request carries the geographic location to be queried by the user and the future time range to be predicted. After receiving the acquisition request, the cloud server may predict the user travel information at the geographic location in the future time range according to the first historical travel data. The user travel information corresponding to the geographic location will then be sent to the user device. In one embodiment, the geographic location may be a current geographic location of the user, or may be other geographic locations that the user requests to query for travel information (for example, the user is currently at a geographic location A, but the user wants to query for user travel information at a geographic location B in the future time range); or the geographic location may be a current geographic location of the user and other geographic locations that the user requests to query for travel information. In one embodiment, referring to the diagram of an interface shown in FIG. 11, an input box 1112 is set on the left of a virtual control 1110. Once the user inputs a geographic location to be queried and a future time range to the input box 1112 and clicks the virtual control 1110 on the right, an acquisition request carrying the geographic location and the future time range can be sent to the cloud server. Certainly, FIG. 10 and FIG. 11 are both interface display examples; and the manner of sending an acquisition request to the cloud server through the user device by the user is not limited in the illustrated embodiments.

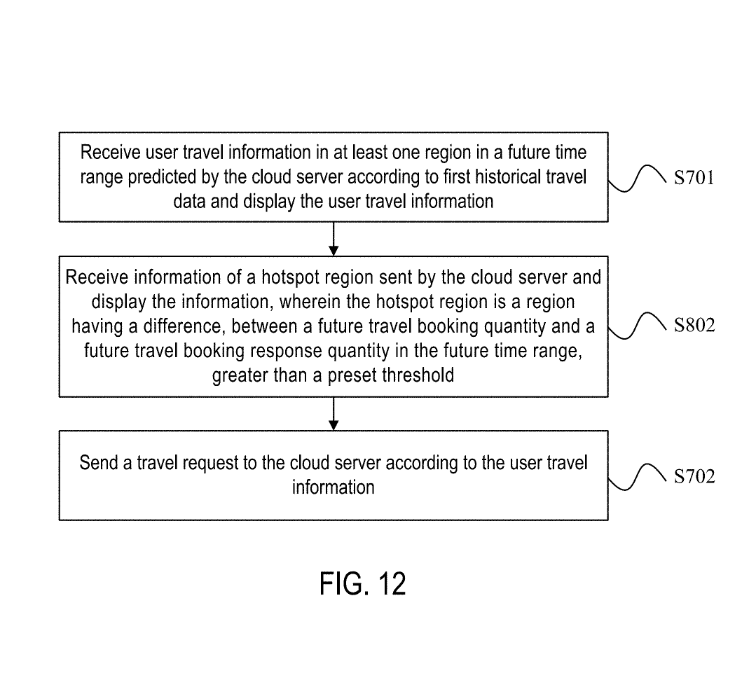

FIG. 12 is a flow diagram illustrating a method for predicting future travel volumes of geographic regions based on historical transportation network data according to some embodiments of the disclosure.

The embodiment in FIG. 12 illustrates a method performed by a user device after the cloud server pushes the predicted information of a hotspot region to the user device. Based on the aforementioned embodiment, the method may further include the following steps.

S802: Receive information of a hotspot region sent by the cloud server and display the information, wherein the hotspot region is a region having a difference, between a future travel booking quantity and a future travel booking response quantity in the future time range, greater than a preset threshold.

Specifically, for embodiments of methods performed by the cloud server to determine a hotspot region, reference may be made to the specific embodiments discussed in the connection with FIG. 4, the disclosure of which is incorporated herein by reference in its entirety. The hotspot region is a region having a difference, between a future travel booking quantity and a future travel booking response quantity in the future time range, greater than a preset threshold. After determining a hotspot region, the cloud server sends information regarding the hotspot region to the user device. In one embodiment, the information regarding the hotspot region may be an identifier of the hotspot region or the latitude and longitude coordinates of the hotspot region, and so on.

After receiving the information regarding the hotspot region, the user device may display the hotspot region according to the received information. The user can learn which regions are the current hotspot regions and then decide whether to avoid the hotspot regions when sending a travel request.

In one embodiment, after receiving the information regarding the hotspot region, the user device may further determine a time and a place for sending a travel request to the cloud server according to the previously received user travel information and the hotspot region information. The travel request is then sent to the cloud server according to the determined time and place for sending the travel request. The user can then send a travel request to the cloud server in a targeted manner according to the detailed predicted information, thereby greatly improving the response rate of users' travel requests.

In one embodiment, if the geographic location that the user requests to query is within a hotspot region, the user may send a fee increasing request to the cloud server through the user device to notify the cloud server that the current user is willing to pay more in order to obtain the car-hailing service. When a cloud server receives the fee increasing request, the cloud server first allocates, according to the fee increasing request, a service device providing a travel service to the user, thereby greatly improving the response rate of the travel requests and enhancing user experience.

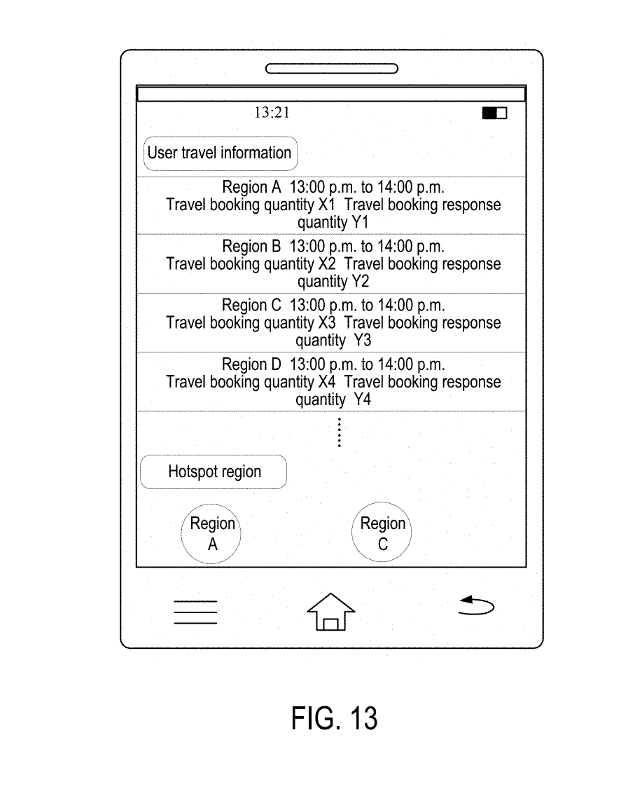

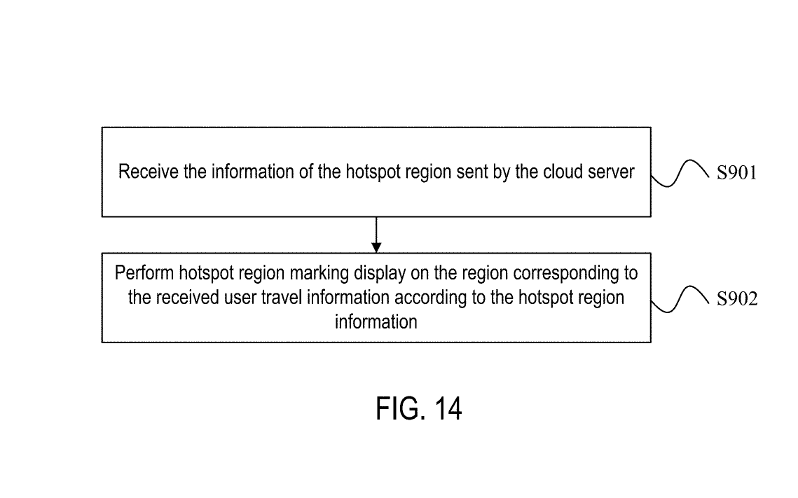

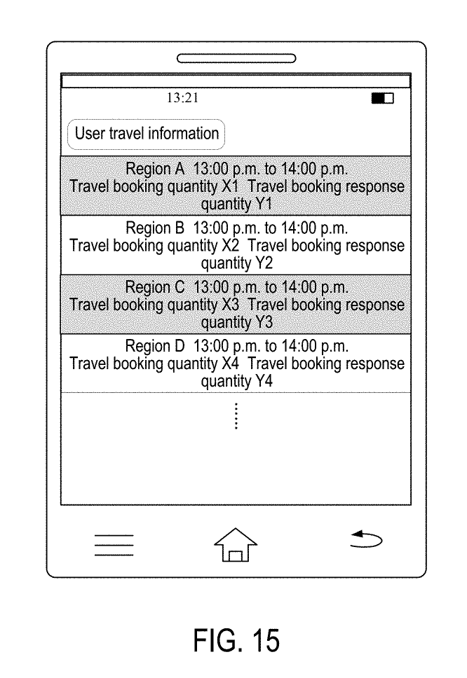

In one embodiment, when displaying the hotspot region according to the hotspot region information, the user device may choose to display the hotspot region and the region corresponding to the previously displayed user travel information separately. An example can be seen in the interface diagram shown in FIG. 13. In one embodiment, hotspot region marking may be performed on the region corresponding to the previously received user travel information according to the information regarding the hotspot region. Examples can be seen by referring to the flow diagram illustrating a method for predicting future travel volumes of geographic regions based on historical transportation network data provided in one embodiment shown in FIG. 14, and by referring to the interface diagrams shown from FIG. 15 to FIG. 18. The aforementioned step S801 may specifically include the following steps.

S901: Receive the hotspot region information sent by the cloud server.

S902: Perform hotspot region marking display on the region corresponding to the received user travel information according to the hotspot region information.

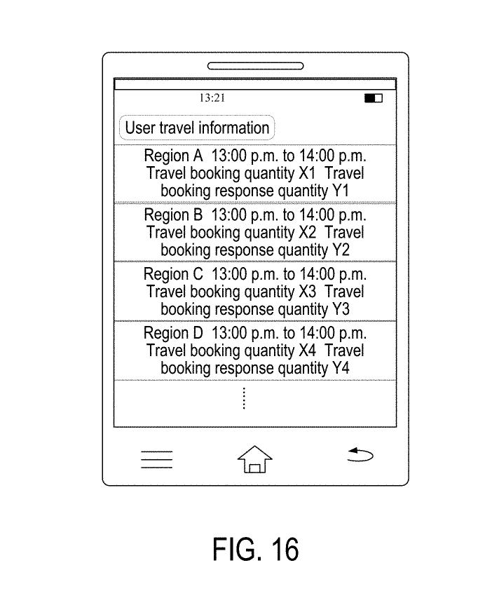

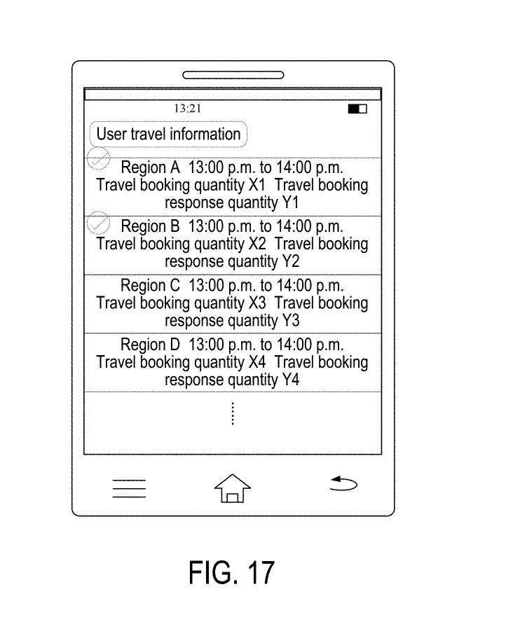

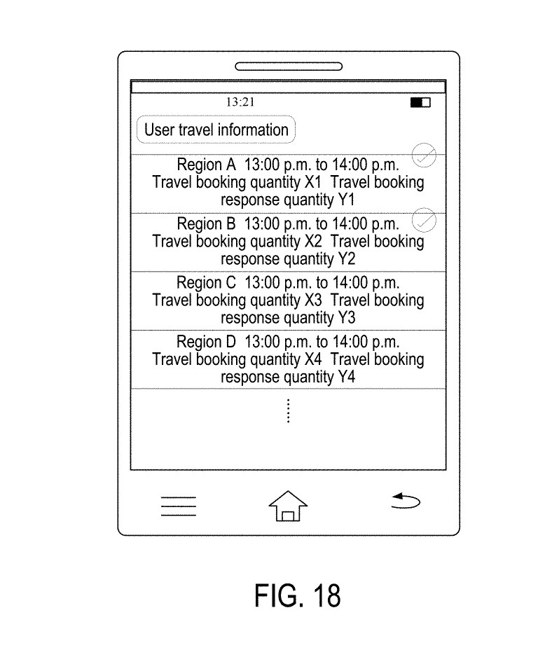

Specifically, when the region corresponding to the received user travel information is a hotspot region, a highlighting display on colors of the region corresponding to the user travel information can be optionally performed. That is, the color of the hotspot region is marked separately from the color of regions corresponding to other user travel information. An example (using shading, instead of coloring) is shown in FIG. 15. In one embodiment, the region corresponding to the user travel information may be positioned and displayed as a first item on a list of regions. That is, if the previously received user travel information is displayed by items, the hotspot region and the user travel information corresponding to the hotspot region are displayed at the top. An example can be seen in FIG. 16. In one embodiment, upper-left hover marking display or upper-right hover marking display may be performed on the region corresponding to the user travel information. An example can be seen in FIG. 17 or FIG. 18.

In the method for predicting future travel volumes of geographic regions based on historical transportation network data provided in this embodiment, information of a hotspot region sent by a cloud server is received, and the hotspot region is displayed to a user according to the information regarding the hotspot region. The user can then send a travel request to the cloud server in a targeted manner, thereby greatly improving the response rate of the travel requests, and greatly facilitating the user's travel.

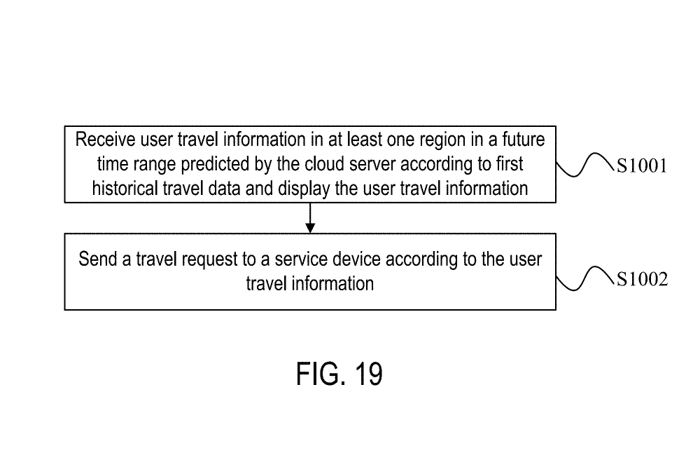

FIG. 19 is a flow diagram illustrating a method for predicting future travel volumes of geographic regions based on historical transportation network data according to some embodiments of the disclosure.

This embodiment involves a process in which a user device acquires user travel information in a future time range so as to obtain a car-hailing service according to the user travel information. As shown in FIG. 19, the method includes the following steps.

S1001: Receive user travel information in at least one region in a future time range predicted by the cloud server according to first historical travel data and display the user travel information.

The first historical travel data represents historical travel booking information for different regions of the map, and the user travel information comprises a future travel booking quantity and a future travel booking response quantity in the region within the future time range.

For the step of S1001, reference may be made to the specific methods introduced in the aforementioned embodiments, the disclosure of which is incorporated herein by reference in its entirety. After the cloud server acquires user travel information in at least one region in a future time range, the cloud server sends the user travel information to a user device; and the user device displays the information, so that a user can view the user travel information through an interface of the user device.

S1002: Send a travel request to a service device according to the user travel information.

Specifically, after the user learns about user travel information in at least one region in the future time range, the user selectively sends a travel request to a service device according to the user travel information. In one embodiment, if the service device is close to the user device, a travel request may be sent to the service device in a targeted manner by Bluetooth or other near field communication methods. The service device can then provide a travel service to the user. For the specific manner of displaying the user travel information, reference may be made to FIG. 10, the disclosure of which is incorporated herein by reference in its entirety.

In the method for predicting future travel volumes of geographic regions based on historical transportation network data provided in this embodiment, user travel information in at least one region in a future time range sent by a cloud server is received and pushed to a user. The user then selectively sends a travel request to the service device through a user device; in this way, the user can avoid situations where the user may have to hail a car during peak hours or hail a car in regions with few responding vehicles, thereby greatly improving the timely response rate for car-hailing, thereby matching a travel requirement of a user with services provided by a service device. Not only the travel requirement of the user is satisfied, a user's experience in this regard is also greatly enhanced.

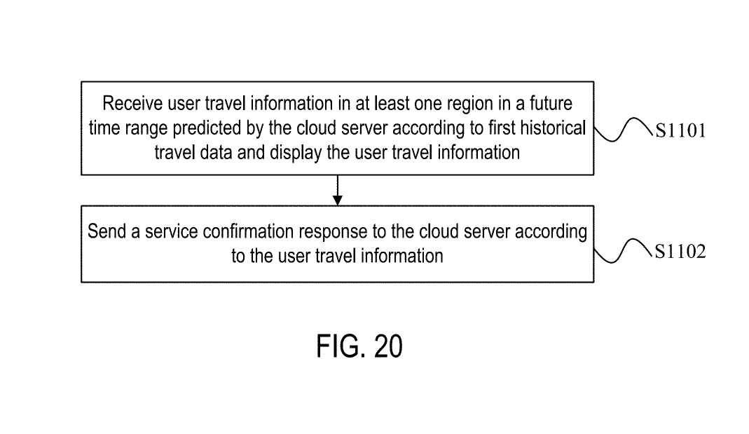

FIG. 20 is a flow diagram illustrating a method for predicting future travel volumes of geographic regions based on historical transportation network data according to some embodiments of the disclosure.

This embodiment involves a process in which a service device acquires user travel information in a future time range so as to provide a car-hailing service to a user according to the user travel information. As shown in FIG. 20, the method includes the following steps.

S1101: Receive user travel information in at least one region in a future time range predicted by the cloud server according to first historical travel data and display the user travel information. In one embodiment, the first historical travel data represents historical travel booking information for different regions of the map, and the user travel information comprises a future travel booking quantity and a future travel booking response quantity in the region within the future time range.

S1102: Send a service confirmation response to the cloud server according to the user travel information.

Specifically, reference to how the cloud server predicts user travel information in at least one region in a future time range according to first historical travel data can be made by referring to the method discussed in the aforementioned embodiment, the disclosure of which is incorporated herein by reference in its entirety. After the cloud server acquires user travel information in at least one region in a future time range, the cloud server sends the user travel information to a service device. The service device displays the information, so that a user of the service device (for example, a car owner or a driver, the following embodiment is described by using the user of the service device being a driver as an example) can view the user travel information through an interface of the service device. In one embodiment, the service device may display the predicted user travel information by pages or by items; or may display the predicted user travel information through images or animation; the animation display may be accompanied by corresponding voice instructions. The user travel information includes a future travel booking quantity and a future travel booking response quantity (namely, the quantity of future travel bookings responded to by service devices) in each region in the future time range. In one embodiment, the regions involved in this embodiment may be a Geohash grid obtained after Geohash processing is performed on basic geographic information of the map; or they may be administrative regions or other regions on the map. In one embodiment, the future time range may be a current day, a certain time period on a current day, or a few consecutive days in the future. The future time range is not limited in this embodiment.

After the driver learns about user travel information in at least one region in the future time range, the driver learns which regions have a higher number of travel booking quantity and which regions have a lower number of travel booking quantity. Further, the driver may learn about information such as which regions have large travel booking response quantities according to the user travel information. The driver can then selectively send a service confirmation response to the cloud server. For example, by sending a service confirmation response carrying a region providing a service, regions far from the current location of the service device can then be avoided. The cloud server learns about service devices capable of providing travel services in the future time range; and thus, upon receiving a travel request of the user at a certain time in the future, the cloud server can properly allocate a service device providing a travel service to a user.

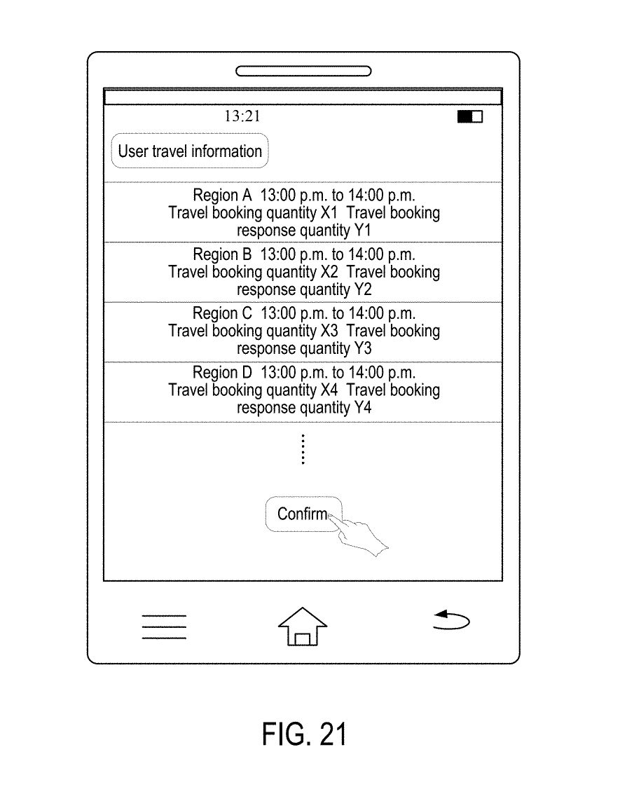

In one embodiment, the service device may deploy a virtual control 2110 on the interface displaying the predicted user travel information; and a service confirmation response to the cloud server can be sent once clicking the virtual control 2110 (as illustrated in the interface diagram illustrated in FIG. 21). The cloud server records service confirmation responses of various service devices; and upon receiving a travel request of a user, the cloud server matches the travel request with an appropriate service device. That is, the service device responds to the user request on the service platform and provides a travel service accordingly.

In the method for predicting future travel volumes of geographic regions based on historical transportation network data provided in this embodiment, user travel information in at least one region in a future time range sent by a cloud server is received and pushed to a service device. The service device then selectively sends a service confirmation response to the cloud server according to the user travel information so as to provide service to a user. As a result, a travel request of the user device may be responded to in time. Such a mechanism ensures that a travel request of a user matches a service device providing a service, meeting the user's travel demand and fulfilling a car owner's needs in earnings, thereby greatly improving both the user and the car owner's service experience.

In one embodiment, the user travel information may be pushed to the service device by the cloud server proactively; or the service device may send an acquisition request carrying a future time range (namely, a predicted time period) to the cloud server to query user travel information in at least one region of the map in the future time range. The embodiments do not impose any limitation in this regard. In one embodiment, the acquisition request may further include a geographic location; and then step S1101 may be: receiving the user travel information, predicted by the cloud server according to the first historical travel data that corresponds to the geographic location.

That is to say, when the driver needs to query user travel information at a certain geographic location in a future time range, the driver may send an acquisition request to the cloud server through the service device. The acquisition request includes the geographic location to be queried by the user and the future time range to be predicted. After receiving the acquisition request, the cloud server may predict the user travel information at the geographic location in the future time range according to the first historical travel data. The user travel information corresponding to the geographic location will then be sent to the service device. In one embodiment, the geographic location may be a current geographic location of the driver, or may be other geographic locations that the driver requests to query for travel information (for example, the driver is currently at a geographic location A, but the driver wants to query for user travel information at a geographic location B in the future time range); or the geographic location may be a current geographic location of the driver and other geographic locations that the driver requests to query for travel information. In one embodiment, referring to interface diagram illustrated in FIG. 11, once the user inputs a geographic location to be queried and a future time range to the input box 1112 and clicks the virtual control 1110 on the right, an acquisition request carrying the geographic location and the future time range can be sent to the cloud server.

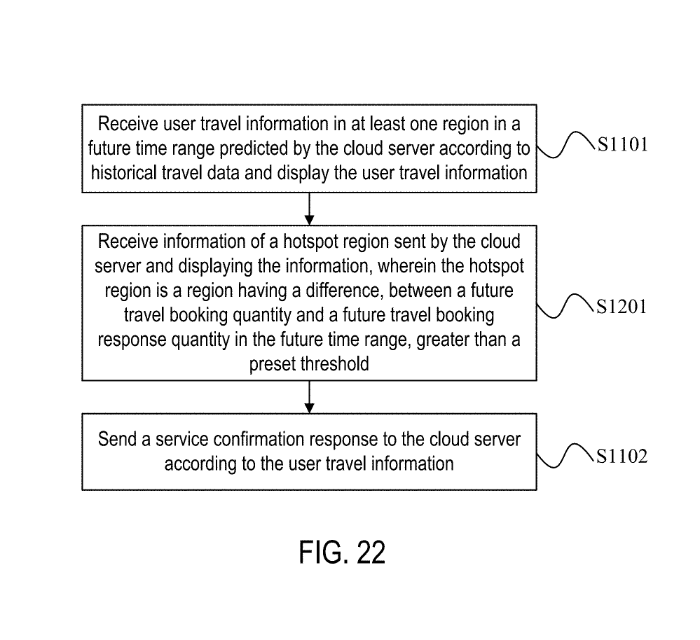

FIG. 22 is a flow diagram illustrating a method for predicting future travel volumes of geographic regions based on historical transportation network data according to some embodiments of the disclosure.

This embodiment involves a processing procedure of the service device after the cloud server pushes the predicted information of a hotspot region to the service device. Based on the aforementioned embodiment, the method may further include the following steps. Note that steps S1101 and S1102 illustrated in FIG. 22 may be similar or identical to those steps described in FIG. 20, the disclosure of which is incorporated by reference in its entirety.

S1201: Receive information of a hotspot region sent by the cloud server and displaying the information, wherein the hotspot region is a region having a difference, between a future travel booking quantity and a future travel booking response quantity in the future time range, greater than a preset threshold.

Specifically, for the specific process that the cloud server determines a hotspot region, reference may be made to the description of the embodiments shown in FIG. 4, the disclosure of which is incorporated by reference in its entirety. The hotspot region is a region having a difference, between a future travel booking quantity and a future travel booking response quantity in the future time range, greater than a preset threshold. After determining a hotspot region, the cloud server sends information regarding the hotspot region to the service device. In one embodiment, the information regarding the hotspot region may be an identifier of the hotspot region or the latitude and longitude coordinates of the hotspot region, and so on.

After receiving the information regarding the hotspot region, the service device may display the hotspot region according to the information regarding the hotspot region. The user of the service device can learn which regions are the current hotspot regions and then decide whether to go to the current hotspot region to provide a travel service to a user.

In one embodiment, after receiving the information regarding the hotspot region, the service device may determine, according to the previously received user travel information and the hotspot region information, a time and a place for providing a car-hailing service to a user device. The time and the place for providing the car-hailing service are carried in the service confirmation response and sent to the cloud server, so as to avoid the situation in which the service device blindly provides a car-hailing service in a certain region in a certain time period and miss the regions or time periods with large travel booking quantities can be avoided, thereby greatly improving the booking response rate of the service device and meeting the user's travel demand. A car owner's earnings need will also be met and both the user and the car owner's service experience are highly improved.

In one embodiment, if the geographic location that the user requests to query is within a hotspot region, the user may send a fee increasing request to the cloud server through the service device to notify the cloud server that the current driver is willing to provide a car-hailing service if the fee is increased. When the cloud server receives the fee increasing request, the cloud server sends the fee increasing request to user devices in the geographic location of the region and user devices then make choices. The service device provides a car-hailing service first to a user agreeing to fee increase, thereby guaranteeing earnings of a car owner of a service device in a hotspot region and enhancing user experience.

In one embodiment, when displaying the hotspot region according to the hotspot region information, the service device may choose to display the hotspot region and the region corresponding to the previously displayed user travel information separately. An example can be seen in interface diagram illustrated in FIG. 13. In one embodiment, hotspot region marking may be performed on the region corresponding to the previously received user travel information according to the hotspot region information. Examples can be seen from the interface diagrams shown in FIGS. 15 through 18. That is, when the region corresponding to the received user travel information is a hotspot when the region corresponding to the received user travel information is a hotspot region, a highlighting display on colors of the region corresponding to the user travel information can be performed optionally. That is, the color of the hotspot region is marked separately from the color of regions corresponding to other user travel information. An example is shown in FIG. 15. In one embodiment, position-first display may be performed on the region corresponding to the user travel information. That is, if the previously received user travel information is displayed by items, the hotspot region and the user travel information corresponding to the hotspot region are displayed at the top. An example can be seen in FIG. 16. In one embodiment, upper-left hover marking display or upper-right hover marking display may be performed on the region corresponding to the user travel information. An example can be seen in FIG. 17 or FIG. 18.

In the method for predicting future travel volumes of geographic regions based on historical transportation network data provided in this embodiment, information of a hotspot region sent by a cloud server is received, and the hotspot region is displayed to a user of a service device according to the information regarding the hotspot region. The user at the service device then selectively sends a service confirmation response to the cloud server according to the user travel information so as to provide service to a user. As a result, a travel request of the user device may be responded to in time. Such a mechanism ensures that a travel request of a user matches a service device providing a service, meeting the user's travel demand and fulfilling a car owner's needs in earnings, thereby greatly improving both the user and the car owner's service experience.

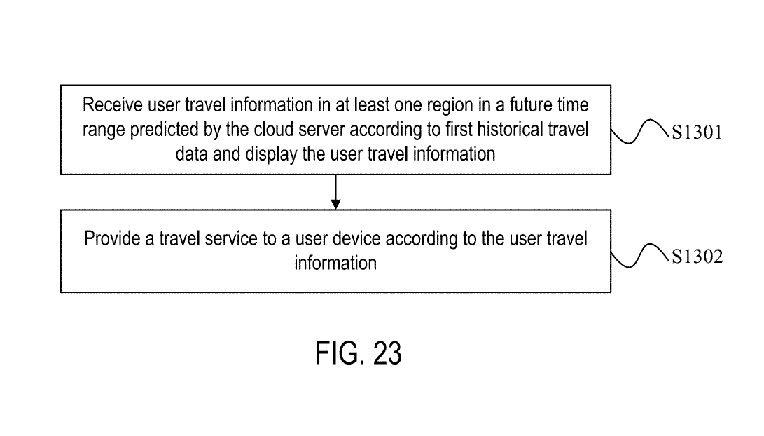

FIG. 23 is a flow diagram illustrating a method for predicting future travel volumes of geographic regions based on historical transportation network data according to some embodiments of the disclosure.

This embodiment involves a process in which a service device acquires user travel information in a future time range so as to provide a car-hailing service to a user according to the user travel information. As shown in FIG. 23, the method includes the following steps.

S1301: Receive user travel information in at least one region in a future time range predicted by the cloud server according to first historical travel data and display the user travel information.

The first historical travel data represents historical travel booking information for different regions of the map, and the user travel information comprises a future travel booking quantity and a future travel booking response quantity in the region within the future time range.

For step S1301, reference may be made to the methods introduced in the aforementioned embodiment, the disclosure of which is incorporated by reference in its entirety. After the cloud server acquires user travel information in at least one region in a future time range, the cloud server sends the user travel information to a service device; and the service device displays the information, so that a driver can view the predicted user travel information through an interface of the service device.

S1302: Provide a travel service to a user device according to the user travel information.

Specifically, after receiving the user travel information, the service device can, according to the predicted user travel information, learn which region has a higher number of future travel requests and learn about the number of responded future travel requests in the region. The service device can then decide whether to provide services to a user in the region. For example, the service device may, through the predicted user travel information in the at least one region within the future time range, learn that a future travel booking quantity in region A on Monday is 1000 and a future travel booking response quantity in region A exceeds 98% future travel booking quantity, and that a future travel booking quantity in region B on Monday is 500 and a future travel booking response quantity in region B is 20% future travel booking quantity. The service device can choose to go to region B according to the information to provide a travel service to a user; in this way, it can be ensured that a travel request of a user in region B is satisfied, and earnings of a car owner of the service device is also guaranteed, thereby greatly improving the service experience for both the user and the car owner.

In the method for predicting future travel volumes of geographic regions based on historical transportation network data provided in this embodiment, user travel information in at least one region in a future time range sent by a cloud server is received and pushed to a service device. The service device then provides service to a user according to the user travel information. As a result, a travel request of the user device may be responded to in time. Such a mechanism ensures that a travel request of a user matches a service device providing a service, meeting the user's travel demand and fulfilling a car owner's needs in earnings, thereby greatly improving both the user and the car owner's service experience.

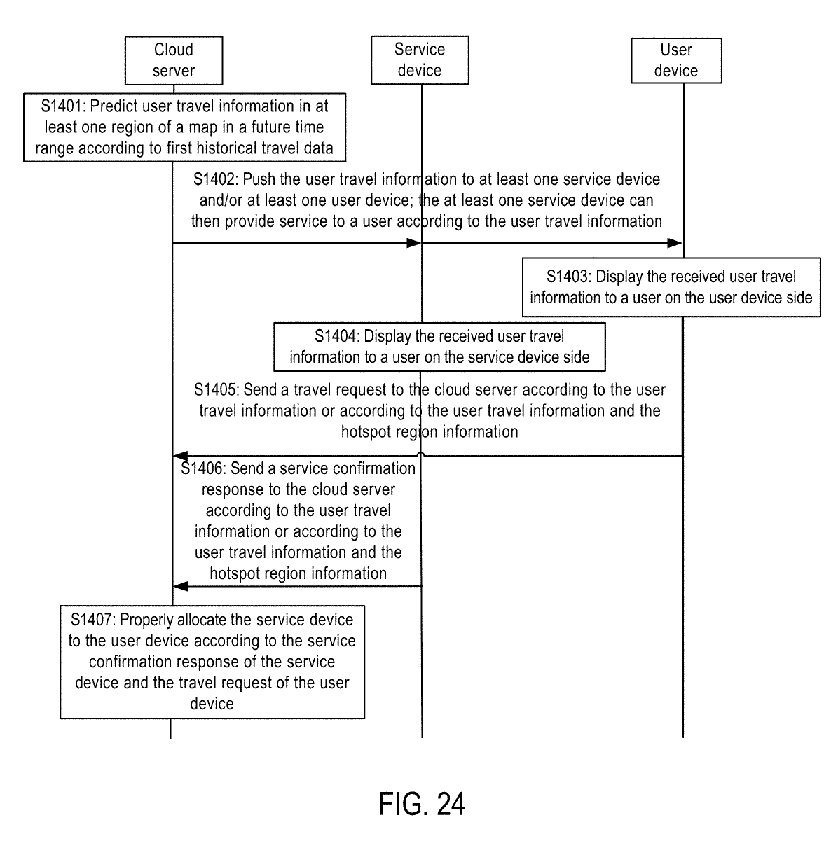

FIG. 24 is a signaling flow diagram illustrating a method for predicting future travel volumes of geographic regions based on historical transportation network data according to some embodiments of the disclosure.

This embodiment involves a processing procedure in that the cloud server predicts, for a user device and a service device, user travel information in at least one region in a future time range according to first historical travel data; and the user device and the service device provide a corresponding query or car-hailing service to a user according to the user travel information. As shown in FIG. 24, the method includes the following steps.

S1401: The cloud server predicts user travel information in at least one region of a map in a future time range according to first historical travel data. In one embodiment, the first historical travel data represents historical travel booking information for different regions of the map, and the user travel information comprises a future travel booking quantity and a future travel booking response quantity in the region within the future time range.

S1402: The cloud server pushes the user travel information to at least one service device and/or at least one user device; the at least one service device can then provide service to a user according to the user travel information.

S1403: The user device displays the received user travel information to a user on the user device side.

S1404: The service device displays the received user travel information to a user on the service device side. In one embodiment, after step S1401, the cloud server may further determine information of a hotspot region according to user travel information in each region in the future time range. For the specific determination process, reference may be made to the embodiment shown in FIG. 4, the disclosure of which is incorporated by reference in its entirety. Therefore, in one embodiment, after step S1402, the cloud server may further send the hotspot region information to the at least one user device and the at least one service device.

S1405: The user device sends a travel request to the cloud server according to the user travel information or according to the user travel information and the hotspot region information.

S1406: The service device sends a service confirmation response to the cloud server according to the user travel information or according to the user travel information and the hotspot region information.

S1407: The cloud server properly allocates the service device to the user device according to the service confirmation response of the service device and the travel request of the user device.

Details of steps S1401 to S1407 may be found in the description of the embodiments discussed in connection with FIGS. 2 through 23 above. The implementation principles and technical effects are similar, which will not be repeated herein.

An apparatus for predicting future travel volumes of geographic regions based on historical transportation network data according to one or more embodiments of the disclosure will be described in detail below. Part or all of the apparatus for predicting future travel volumes of geographic regions based on historical transportation network data may be implemented on a cloud server or a device managing the cloud server; or may be integrated in a user device; or may be integrated in a service device. Those skilled in the art can understand that part or all of the apparatus for predicting future travel volumes of geographic regions based on historical transportation network data can be formed by configuring commercially available hardware components through steps instructed in this solution. For example, modules in the following embodiments involving processing functions and determining functions may be implemented using components such as a single-chip microcomputer, a microcontroller, and a microprocessor.

The following are apparatus embodiments of the disclosure, which can be used for executing the disclosed method embodiments. For details not disclosed in the apparatus embodiments disclosed herein, reference may be made to the method embodiments discussed previously.

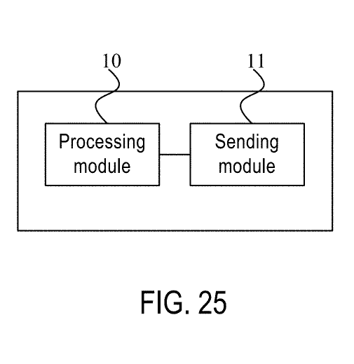

FIG. 25 is a diagram of an apparatus for predicting future travel volumes of geographic regions based on historical transportation network data according to some embodiments of the disclosure.

The apparatus for predicting future travel volumes of geographic regions based on historical transportation network data may be implemented by software, hardware, or a combination of software and hardware. As shown in FIG. 25, the apparatus may include: a processing module 10 and a sending module 11.

The processing module 10 is configured to predict user travel information in at least one region of a map in a future time range according to first historical travel data, wherein the first historical travel data represents historical travel booking information for different regions of the map, and the user travel information comprises a future travel booking quantity and a future travel booking response quantity in the region within the future time range.

The sending module 11 is configured to push the user travel information to at least one service device and/or at least one user device.

The apparatus for predicting future travel volumes of geographic regions based on historical transportation network data provided in this embodiment can execute the aforementioned method embodiments, and has similar implementation principles and technical effects. Details of the method embodiments discussed previously will not be repeated herein and are incorporated herein by reference in their entirety.

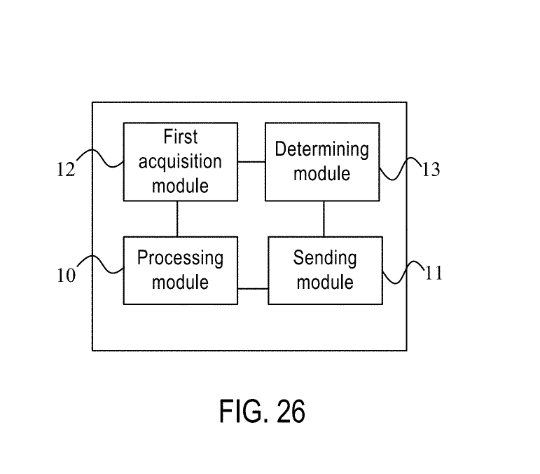

FIG. 26 is a diagram of an apparatus for predicting future travel volumes of geographic regions based on historical transportation network data according to some embodiments of the disclosure.

Based on the embodiment shown in FIG. 25, the apparatus for predicting future travel volumes of geographic regions based on historical transportation network data may further include: a first acquisition module 12 and a determining module 13.

Specifically, the first acquisition module 12 is configured to acquire, according to user travel information in each of the regions within the future time range, a difference between a future travel booking quantity and a future travel booking response quantity in each of the regions within the future time range.

The determining module 13 is configured to determine a region having a difference greater than a preset threshold as a hotspot region; and

The sending module 11 is further configured to push information regarding the hotspot region to the at least one service device.

Further, in one embodiment, the regions are grids obtained after basic geographic location information of the map is discretized, and each grid corresponds to a region of the map represented by latitude and longitude coordinates; and the information regarding the hotspot region is Point of Interest (POI) information included in the grid having the difference greater than the preset threshold.

The apparatus for predicting future travel volumes of geographic regions based on historical transportation network data provided in this embodiment can execute the aforementioned method embodiments, and has similar implementation principles and technical effects. Details of the method embodiments discussed previously will not be repeated herein and are incorporated herein by reference in their entirety.

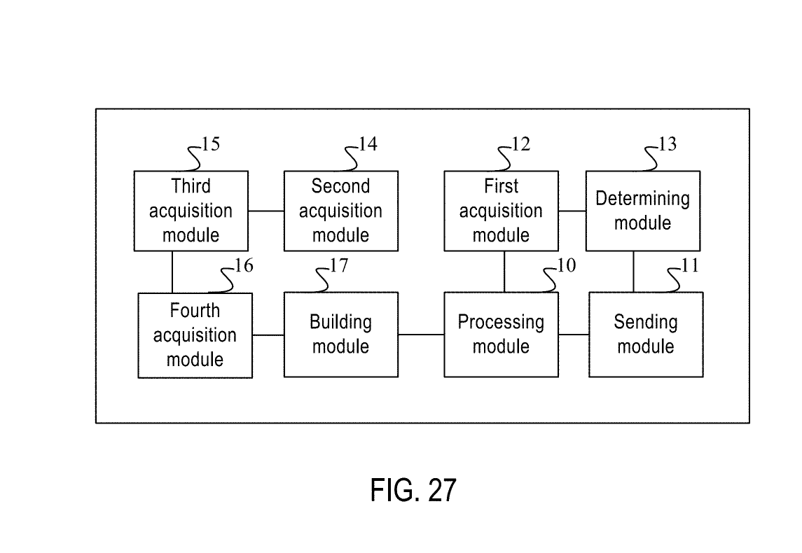

FIG. 27 is a diagram of an apparatus for predicting future travel volumes of geographic regions based on historical transportation network data according to some embodiments of the disclosure.

Based on the embodiment shown in FIG. 26, the apparatus for predicting future travel volumes of geographic regions based on historical transportation network data may further include: a second acquisition module 14, a third acquisition module 15, a fourth acquisition module 16, and a building module 17.

Specifically, the second acquisition module 14 is configured to perform discretization processing on the basic geographic location information of the map to obtain at least one grid.

The third acquisition module 15 is configured to add time stamps to all acquired first historical travel bookings according to a preset time period division policy, so as to obtain at least one second historical travel booking, wherein the time stamp comprises a date when the first historical travel booking is scheduled and an identifier of a time period during which the first historical travel booking is scheduled; and the first historical travel booking includes latitude and longitude coordinate information corresponding to the first historical travel booking and the time when the first historical travel booking is scheduled.

The fourth acquisition module 16 is configured to generate second historical travel data according to each of the second historical travel bookings and the obtained response information, wherein the second historical travel data comprises at least one third historical travel booking, each third historical travel booking comprises the second historical travel booking and a response state of the second historical travel booking; and the response information is used to indicate the response state for each of the second historical travel bookings.

The building module 17 is configured to map the second historical travel data to the at least one grid according to latitude and longitude coordinate information of each of the third historical travel bookings in the second historical travel data to obtain the first historical travel data.

In one embodiment, the first historical travel data specifically includes: a historical travel booking quantity and a historical travel booking response quantity in each of the grids during each time period on each historical date; and accordingly, the user travel information specifically comprises: a future travel booking quantity and a future travel booking response quantity in the grid during each time period on a future date.

In one embodiment, the first historical travel data further includes: a response waiting time and/or a booking quantity for historical travel bookings in each of the grids during each time period on each historical date, wherein the booking quantity is responded to by service devices in the grid where the historical travel bookings take place.

The apparatus for predicting future travel volumes of geographic regions based on historical transportation network data provided in this embodiment can execute the aforementioned method embodiments, and has similar implementation principles and technical effects. Details of the method embodiments discussed previously will not be repeated herein and are incorporated herein by reference in their entirety.

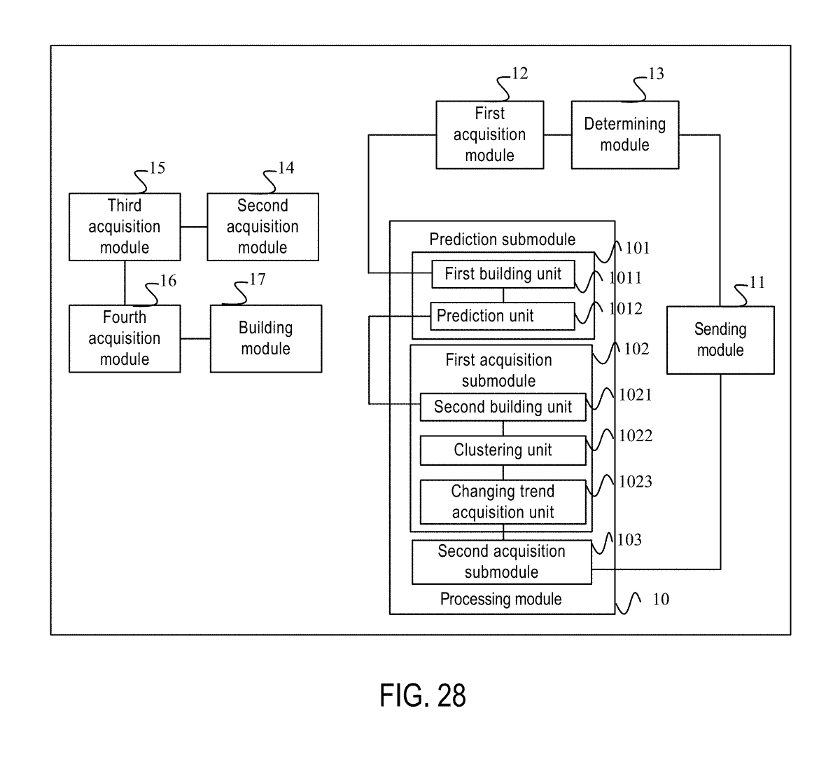

FIG. 28 is a diagram of an apparatus for predicting future travel volumes of geographic regions based on historical transportation network data according to some embodiments of the disclosure.

Based on the embodiment shown in FIG. 27, the apparatus for predicting future travel volumes of geographic regions based on historical transportation network data may further include: a prediction submodule 101, a first acquisition submodule 102, and a second acquisition submodule 103.

Specifically, the prediction submodule 101 is configured to predict a total travel booking quantity and a total travel booking response quantity for each grid on the current date according to the first historical travel data.

The first acquisition submodule 102 is configured to acquire a first changing trend of historical travel booking quantities and a second changing trend of historical travel booking response quantities in each grid having different date attributes according to the preset time period division policy, wherein the date attributes comprise any one of a workday attribute, a weekend attribute, and a holiday attribute.

The second acquisition submodule 103 is configured to obtain a travel booking quantity in each of the grids during each time period on the current date according to the total travel booking quantity in each of the grids on the current date and the first changing trend, and obtain a travel booking response quantity in each of the grids during each time period on the current date according to the total travel booking response quantity in each of the grids on the current date and the second changing trend.

Still referring to the apparatus structure shown in the FIG. 28 above, the prediction submodule 101 may specifically include a first building unit 1011 and a prediction unit 1012.

Specifically, the first building unit 1011 is configured to build a first time sequence and a second time sequence for each of the grids using the identifier of each grid as a primary key according to the first historical travel data, wherein the first time sequence comprises a total historical travel booking quantity in the grid on each historical date; the second time sequence comprises a total historical travel booking response quantity in the grid on each historical date; and lengths of the first time sequence and the second time sequence are equal to the number of the historical dates in the grid.

The prediction unit 1012 is configured to predict the total travel booking quantity for each grid on the current date according to a first ARIMA model and the first time sequence of each of the grids, and predict the total travel booking response quantity for each grid on the current date according to a second ARIMA model and the second time sequence of each of the grids.

Still referring to the apparatus structure shown in the FIG. 28 above, the first acquisition submodule 102 specifically includes a second building unit 1021, a clustering unit 1022, and a changing trend acquisition unit 1023.

Specifically, the second building unit 1021 is configured to build at least one third time sequence and at least one fourth time sequence for each of the grids using the identifier of each grid and a date dimension as primary keys according to the first historical travel data, wherein the third time sequence comprises historical travel booking quantities during different time periods on a historical date; and the fourth time sequence comprises historical travel booking response quantities during different time periods on the historical date.

The clustering unit 1022 is configured to cluster the historical dates in each of the grids according to a preset date attribute to obtain a first attribute date cluster for each of the grids, wherein the first attribute date cluster comprises multiple historical dates meeting the date attribute requirement.

The changing trend acquisition unit 1023 is configured to obtain a first changing trend of historical travel booking quantities in each grid having the date attribute according to all of the third time sequences under the first attribute date cluster, and obtain a second changing trend of historical travel booking response quantities in each grid having the date attribute according to all of the fourth time sequences under the first attribute date cluster.

In one embodiment, the response waiting time for historical travel bookings in each of the grids during each time period on each historical date specifically comprises at least one of an average response waiting time, a maximum response waiting time, a median response waiting time, and a minimum response waiting time for the historical travel bookings in each of the grids during each time period on each historical date.

In one embodiment, the first historical travel booking further comprises a name of the user placing the first historical travel booking, and/or an address of the user placing the first historical travel booking.

In one embodiment, the response information comprises a name of a driver responding to the second historical travel booking, latitude and longitude coordinate information of a service device when responding to the second historical travel booking, and a time when responding to the second historical travel booking takes place.

The apparatus for predicting future travel volumes of geographic regions based on historical transportation network data provided in this embodiment can execute the aforementioned method embodiments, and has similar implementation principles and technical effects. Details of the method embodiments discussed previously will not be repeated herein and are incorporated herein by reference in their entirety.

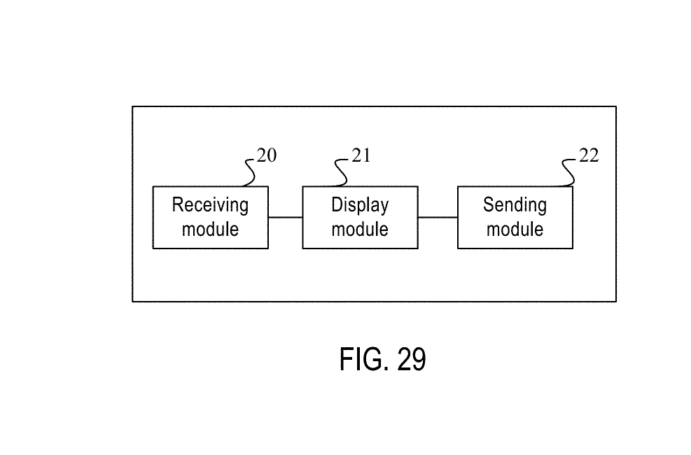

FIG. 29 is a diagram of an apparatus for predicting future travel volumes of geographic regions based on historical transportation network data according to some embodiments of the disclosure.

The apparatus for predicting future travel volumes of geographic regions based on historical transportation network data may be integrated in a user device, and may be implemented by software, hardware, or a combination of software and hardware. As shown in FIG. 29, the apparatus may include a receiving module 20, a display module 21, and a sending module 22.

Specifically, the receiving module 20 is configured to receive user travel information in at least one region in a future time range predicted by a cloud server according to first historical travel data, wherein the first historical travel data represents historical travel booking information for different regions of the map, and the user travel information comprises a future travel booking quantity and a future travel booking response quantity in the region within the future time range.

The display module 21 is configured to display the user travel information.

The sending module 22 is configured to send a travel request to the cloud server according to the user travel information.

The apparatus for predicting future travel volumes of geographic regions based on historical transportation network data provided in this embodiment can execute the aforementioned method embodiments, and has similar implementation principles and technical effects. Details of the method embodiments discussed previously will not be repeated herein and are incorporated herein by reference in their entirety.

The receiving module 20 is further configured to information of a hotspot region sent by the cloud server and displaying the information, wherein the hotspot region is a region having a difference, between a future travel booking quantity and a future travel booking response quantity in the future time range, greater than a preset threshold; and the display module 21 is further configured to display the hotspot region.

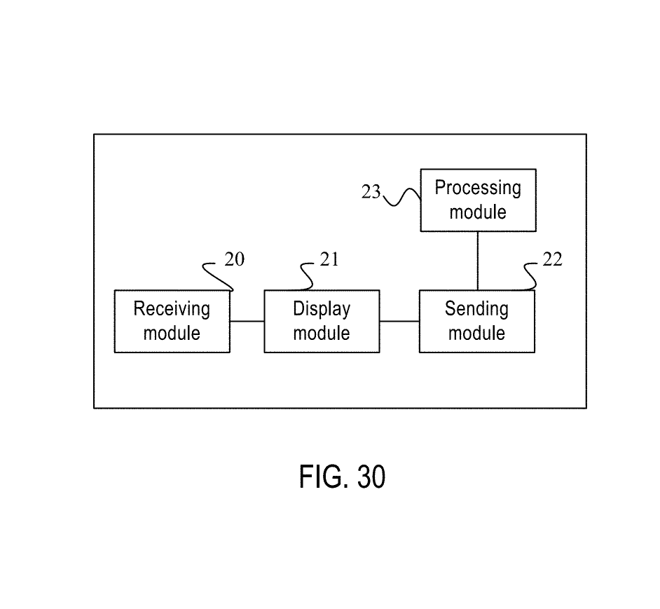

FIG. 30 is a diagram of an apparatus for predicting future travel volumes of geographic regions based on historical transportation network data according to some embodiments of the disclosure.

The apparatus for predicting future travel volumes of geographic regions based on historical transportation network data may be integrated in a user device, and may be implemented by software, hardware, or a combination of software and hardware. Based on the embodiment shown in FIG. 29, the apparatus may further include a processing module 23, as shown in FIG. 30.

Specifically, the processing module 23 is configured to determine, according to the user travel information and the hotspot region information, a time and a location for the travel request to be sent to the cloud server.

The sending module 22 is specifically configured to send the travel request to the cloud server according to the time and the location of the to-be-sent travel request.

Further, the display module 21 is specifically configured to perform, according to the hotspot region information, a hotspot region marking display on the region corresponding to the user travel information received by the receiving module 20.

The apparatus for predicting future travel volumes of geographic regions based on historical transportation network data provided in this embodiment can execute the aforementioned method embodiments, and has similar implementation principles and technical effects. Details of the method embodiments discussed previously will not be repeated herein and are incorporated herein by reference in their entirety.

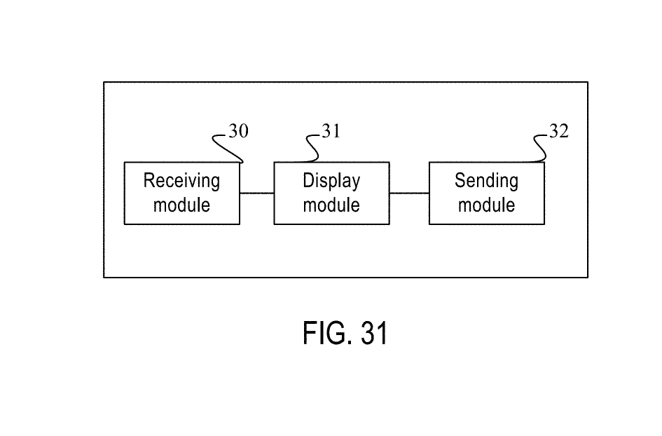

FIG. 31 is a diagram of an apparatus for predicting future travel volumes of geographic regions based on historical transportation network data according to some embodiments of the disclosure.

The apparatus for predicting future travel volumes of geographic regions based on historical transportation network data may be integrated in a user device, and may be implemented by software, hardware, or a combination of software and hardware. As shown in FIG. 31, the apparatus may include a receiving module 30, a display module 31, and a sending module 32.

Specifically, the receiving module 30 is configured to receive user travel information in at least one region in a future time range predicted by a cloud server according to first historical travel data, wherein the first historical travel data represents historical travel booking information for different regions of the map, and the user travel information comprises a future travel booking quantity and a future travel booking response quantity in the region within the future time range.

The display module 31 is configured to display the user travel information.

The sending module 32 is configured to send a travel request to a service device according to the user travel information.

The apparatus for predicting future travel volumes of geographic regions based on historical transportation network data provided in this embodiment can execute the aforementioned method embodiments, and has similar implementation principles and technical effects. Details of the method embodiments discussed previously will not be repeated herein and are incorporated herein by reference in their entirety.

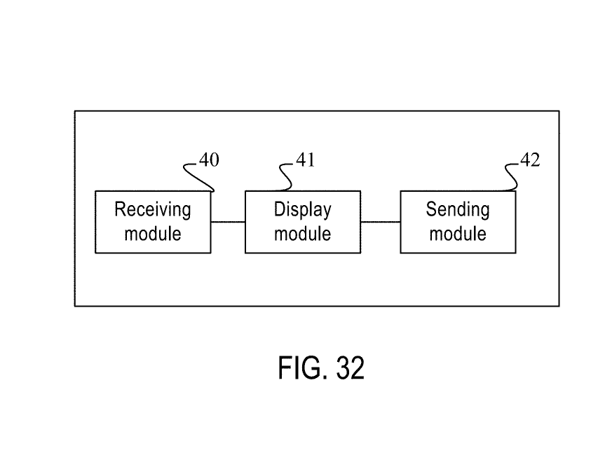

FIG. 32 is a diagram of an apparatus for predicting future travel volumes of geographic regions based on historical transportation network data according to some embodiments of the disclosure.

The apparatus for predicting future travel volumes of geographic regions based on historical transportation network data may be integrated in a service device, and may be implemented by software, hardware, or a combination of software and hardware. As shown in FIG. 32, the apparatus may include a receiving module 40, a display module 41, and a sending module 42.

Specifically, the receiving module 40 is configured to receive user travel information in at least one region in a future time range predicted by a cloud server according to first historical travel data, wherein the first historical travel data represents historical travel booking information for different regions of the map, and the user travel information comprises a future travel booking quantity and a future travel booking response quantity in the region within the future time range.

The display module 41 is configured to display the user travel information.

The sending module 42 is configured to send a service confirmation response to the cloud server according to the user travel information.

The apparatus for predicting future travel volumes of geographic regions based on historical transportation network data provided in this embodiment can execute the aforementioned method embodiments, and has similar implementation principles and technical effects. Details of the method embodiments discussed previously will not be repeated herein and are incorporated herein by reference in their entirety.

In one embodiment, the receiving module 40 is further configured to information of a hotspot region sent by the cloud server and displaying the information, wherein the hotspot region is a region having a difference, between a future travel booking quantity and a future travel booking response quantity in the future time range, greater than a preset threshold; and the display module 41 is further configured to display the hotspot region.

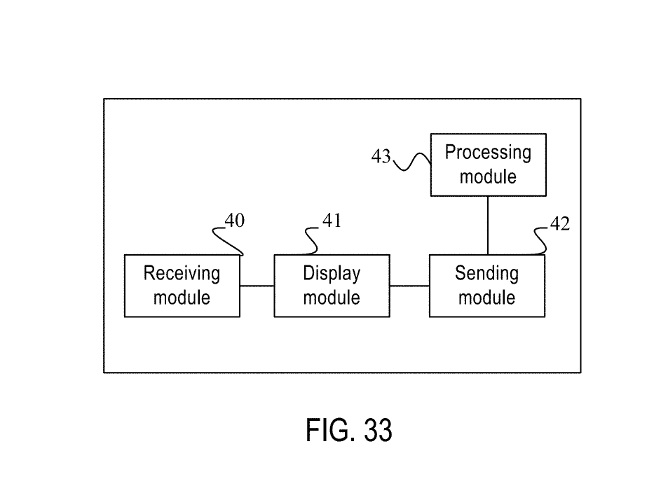

FIG. 33 is a diagram of an apparatus for predicting future travel volumes of geographic regions based on historical transportation network data according to some embodiments of the disclosure.

The apparatus for predicting future travel volumes of geographic regions based on historical transportation network data may be integrated in a service device, and may be implemented by software, hardware, or a combination of software and hardware. Based on the embodiment shown in FIG. 32 above, the apparatus may further include a processing module 43, as shown in FIG. 33.

The processing module 43 is configured to determine, according to the user travel information and the hotspot region information, a time and a location for providing a car-hailing service for a user device.

The sending module 42 is specifically configured to send the service confirmation response carrying the time and the location for providing the car-hailing service to the cloud server.

Further, the display module 41 is specifically configured to perform, according to the hotspot region information, a hotspot region marking display on the region corresponding to the user travel information received by the receiving module 40.

The apparatus for predicting future travel volumes of geographic regions based on historical transportation network data provided in this embodiment can execute the aforementioned method embodiments, and has similar implementation principles and technical effects. Details of the method embodiments discussed previously will not be repeated herein and are incorporated herein by reference in their entirety.

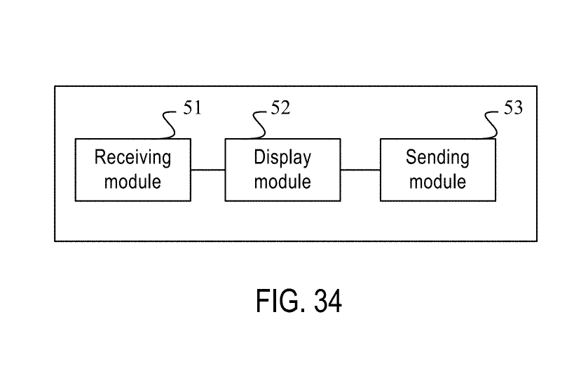

FIG. 34 is a diagram of an apparatus for predicting future travel volumes of geographic regions based on historical transportation network data according to some embodiments of the disclosure.

The apparatus for predicting future travel volumes of geographic regions based on historical transportation network data may be integrated in a service device, and may be implemented by software, hardware, or a combination of software and hardware. As shown in FIG. 34, the apparatus may include a receiving module 51, a display module 52, and a sending module 53.

Specifically, the receiving module 51 is configured to receive user travel information in at least one region in a future time range predicted by a cloud server according to first historical travel data, wherein the first historical travel data represents historical travel booking information for different regions of the map, and the user travel information comprises a future travel booking quantity and a future travel booking response quantity in the region within the future time range;

The display module 52 is configured to display the user travel information.

The sending module 53 is configured to provide a travel service to a user device according to the user travel information.

The apparatus for predicting future travel volumes of geographic regions based on historical transportation network data provided in this embodiment can execute the aforementioned method embodiments, and has similar implementation principles and technical effects. Details of the method embodiments discussed previously will not be repeated herein and are incorporated herein by reference in their entirety.

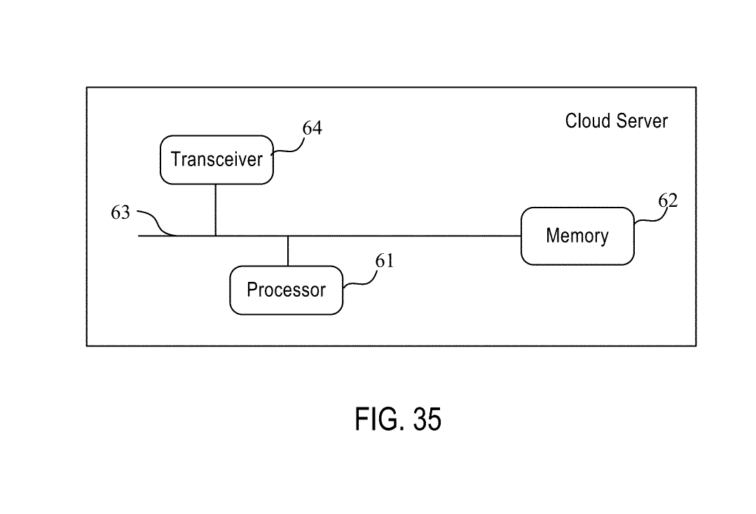

FIG. 35 is a diagram of a cloud server according to some embodiments of the disclosure.

As shown in FIG. 35, the cloud server may include a processor 61, a memory 62, at least one communication bus 63, and a transceiver 64. The communication bus 63 is configured to build a communication connection between elements. The memory 62 may include a high-speed RAM memory, and may further include a non-volatile memory (NVM), such as at least one disk memory. The memory 62 may store various programs for implementing various processing functions and implementing method steps in this embodiment. The transceiver 64 may be a transmitter-receiver having reception and transmission functions; or a transmitter purely having a transmission function; or a transceiver antenna; or may be a radio frequency and baseband unit having signal processing and transmission functions.

In one embodiment, the processor 61, for example, may be implemented by a central processing unit (CPU), an application specific integrated circuit (ASIC), a digital signal processor (DSP), a digital signal processing device (DSPD), a programmable logic device (PLD), a field programmable gate array (FPGA), a controller, a microcontroller, a microprocessor, or other electronic elements.

In this embodiment, the processor 61 is coupled to the transceiver 64 and is configured to predict user travel information in at least one region of a map in a future time range according to first historical travel data, wherein the first historical travel data represents historical travel booking information for different regions of the map, and the user travel information comprises a future travel booking quantity and a future travel booking response quantity in the region within the future time range.

The transceiver 64 is configured to push the user travel information to at least one service device and/or at least one user device.

The cloud server provided in this embodiment can execute the aforementioned method embodiments, and has similar implementation principles and technical effects. Details of the method embodiments discussed previously will not be repeated herein and are incorporated herein by reference in their entirety.

In one embodiment, the processor 61 is further configured to acquire, according to user travel information in each of the regions within the future time range, a difference between a future travel booking quantity and a future travel booking response quantity in each of the regions within the future time range.

The transceiver 64 is further configured to push information regarding the hotspot region to the at least one service device and/or the at least one user device.

In one embodiment, the regions are grids obtained after basic geographic location information of the map is discretized, and each grid corresponds to a region of the map represented by latitude and longitude coordinates; and the information regarding the hotspot region is Point of Interest (POI) information included in the grid having the difference greater than the preset threshold.

In one embodiment, the processor 61 is further configured to perform discretization on the basic geographic location information of the map to obtain at least one grid; and add time stamps to all acquired first historical travel bookings according to a preset time period division policy, so as to obtain at least one second historical travel booking, wherein the time stamp comprises a date when the first historical travel booking is scheduled and an identifier of a time period during which the first historical travel booking is scheduled; and the first historical travel booking includes latitude and longitude coordinate information corresponding to the first historical travel booking and the time when the first historical travel booking is scheduled.

Further, the processor 61 is further configured to generate second historical travel data according to each of the second historical travel bookings and the obtained response information; and map the second historical travel data to the at least one grid according to the latitude and longitude coordinate information of each of the third historical travel bookings in the second historical travel data to obtain the first historical travel data. The second historical travel data comprises at least one third historical travel booking, each third historical travel booking comprises the second historical travel booking and a response state of the second historical travel booking; and the response information is used to indicate the response state for each of the second historical travel bookings.

In one embodiment, the first historical travel data specifically includes: a historical travel booking quantity and a historical travel booking response quantity in each of the grids during each time period on each historical date; and accordingly, the user travel information specifically comprises: a future travel booking quantity and a future travel booking response quantity in the grid during each time period on a future date.

In one embodiment, the first historical travel data further includes: a response waiting time and/or a booking quantity for historical travel bookings in each of the grids during each time period on each historical date, wherein the booking quantity is responded to by service devices in the grid where the historical travel bookings take place.

Further, the processor 61 may be specifically configured to predict a total travel booking quantity and a total travel booking response quantity for each grid on a current date according to the first historical travel data; and acquire first changing trends of historical travel booking quantities and second changing trends of historical travel booking response quantities for each grid under different date attributes according to the preset time period division policy; and obtain a travel booking quantity in each of the grids during each time period on the current date according to the total travel booking quantity in each of the grids on the current date and the first changing trends; and obtain a travel booking response quantity in each of the grids during each time period on the current date according to the total travel booking response quantity in each of the grids on the current date and the second changing trends. The date attributes include any one of a workday attribute, a weekend attribute, and a holiday attribute.

Further, the processor 61 may be further configured to build a first time sequence and a second time sequence for each of the grids using an identifier of each grid as a primary key according to the first historical travel data; and predict the total travel booking quantity in each grid on the current date according to a first ARIMA model and the first time sequence of each of the grids; and predict the total travel booking response quantity in each grid on the current date according to a second ARIMA model and the second time sequence of each of the grids. The first time sequence includes a total historical travel booking quantity in the grid under each historical date; the second time sequence includes a total historical travel booking response quantity in the grid under each historical date. Lengths of the first time sequence and the second time sequence are equal to the number of the historical dates in the grid.

Additionally, the processor 61 may be further configured to build at least one third time sequence and at least one fourth time sequence for each of the grids using the identifier of each grid and a date dimension as primary keys according to the first historical travel data; cluster the historical dates in each of the grids according to a preset date attribute to obtain a first attribute date cluster in each of the grids; the first attribute date cluster includes multiple historical dates meeting the date attribute requirement; and obtain a first changing trend of historical travel booking quantities for each grid under the date attribute according to all third time sequences under the first attribute date cluster; and obtain a second changing trend of historical travel booking response quantities for each grid under the date attribute according to all fourth time sequences under the first attribute date cluster; the third time sequence includes historical travel booking quantities during different time periods on a historical date; and the fourth time sequence includes historical travel booking response quantities during different time periods on the historical date.

In one embodiment, the response waiting time for historical travel bookings in each of the grids during each time period on each historical date specifically comprises at least one of an average response waiting time, a maximum response waiting time, a median response waiting time, and a minimum response waiting time for the historical travel bookings in each of the grids during each time period on each historical date.

In one embodiment, the first historical travel booking further comprises a name of the user placing the first historical travel booking, and/or an address of the user placing the first historical travel booking.

In one embodiment, the response information comprises a name of a driver responding to the second historical travel booking, latitude and longitude coordinate information of a service device when responding to the second historical travel booking, and a time when responding to the second historical travel booking takes place.

The cloud server provided in this embodiment can execute the aforementioned method embodiments, and has similar implementation principles and technical effects. Details of the method embodiments discussed previously will not be repeated herein and are incorporated herein by reference in their entirety.

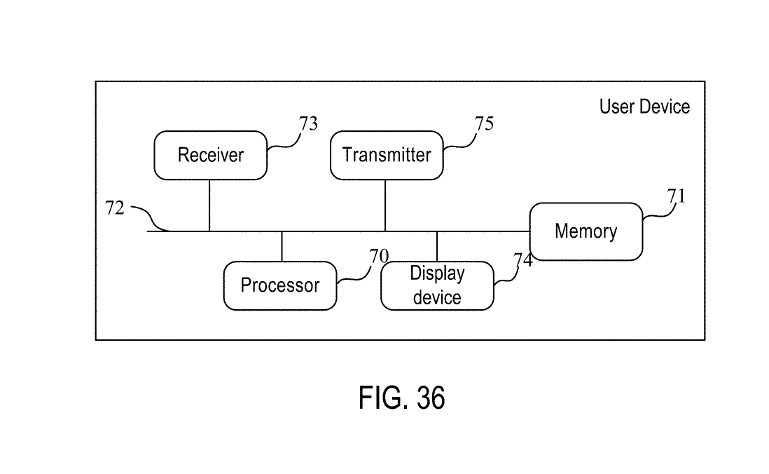

FIG. 36 is a diagram of a user device according to some embodiments of the disclosure.

As shown in FIG. 36, the user device may include a processor 70, a memory 71, at least one communication bus 72, a receiver 73, and a display device 74 and a transmitter 75 that are coupled to the receiver 73. The communication bus 72 is configured to build a communication connection between elements. The memory 71 may include a high-speed RAM memory, and may further include a non-volatile memory (NVM), such as at least one disk memory. The memory may store various programs for implementing various processing functions and implementing method steps in this embodiment. The transmitter 75 or the receiver 73 may be a transmitter-receiver having reception and transmission functions; or a transmitter purely having a transmission function; or a transceiver antenna; or may be a radio frequency and baseband unit having signal processing and transmission functions.

In one embodiment, the processor 70, for example, may be implemented by a central processing unit (CPU), an application specific integrated circuit (ASIC), a digital signal processor (DSP), a digital signal processing device (DSPD), a programmable logic device (PLD), a field programmable gate array (FPGA), a controller, a microcontroller, a microprocessor, or other electronic elements.

In this embodiment, the receiver 73 is configured to receive user travel information in at least one region in a future time range predicted by a cloud server according to first historical travel data, wherein the first historical travel data represents historical travel booking information for different regions of the map, and the user travel information comprises a future travel booking quantity and a future travel booking response quantity in the region within the future time range.

The display device 74 is configured to display the user travel information.

The transmitter 75 is configured to send a travel request to a cloud server or a service device according to the user travel information.

The user server provided in this embodiment can execute the aforementioned method embodiments, and has similar implementation principles and technical effects. Details of the method embodiments discussed previously will not be repeated herein and are incorporated herein by reference in their entirety.

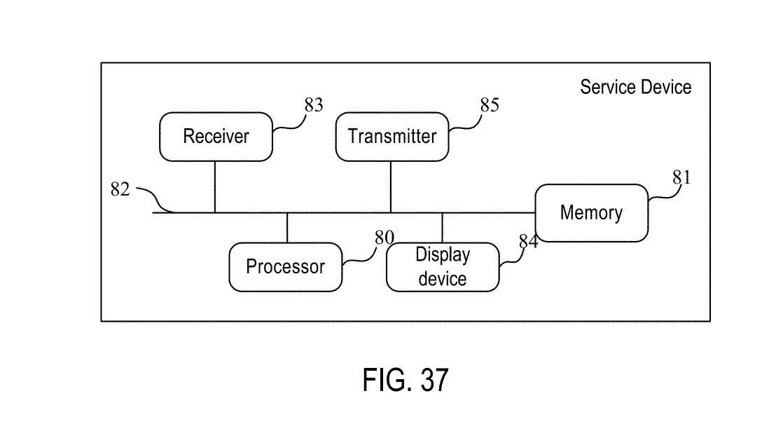

FIG. 37 is a diagram of a service device according to some embodiments of the disclosure.

As shown in FIG. 37, the service device may include a processor 80, a memory 81, at least one communication bus 82, a receiver 83, and a display device 84 and a transmitter 85 that are coupled to the receiver 83. The communication bus 82 is configured to build a communication connection between elements. The memory 81 may include a high-speed RAM memory, and may further include a non-volatile memory (NVM), such as at least one disk memory. The memory may store various programs for implementing various processing functions and implementing method steps in this embodiment. The transmitter 85 or the receiver 83 may be a transmitter-receiver having reception and transmission functions; or a transmitter purely having a transmission function; or a transceiver antenna; or may be a radio frequency and baseband unit having signal processing and transmission functions.

In one embodiment, the processor 80, for example, may be implemented by a central processing unit (CPU), an application specific integrated circuit (ASIC), a digital signal processor (DSP), a digital signal processing device (DSPD), a programmable logic device (PLD), a field programmable gate array (FPGA), a controller, a microcontroller, a microprocessor, or other electronic elements.

In this embodiment, the receiver 83 is configured to receive user travel information in at least one region in a future time range predicted by a cloud server according to first historical travel data, wherein the first historical travel data represents historical travel booking information for different regions of the map, and the user travel information comprises a future travel booking quantity and a future travel booking response quantity in the region within the future time range.

The display device 84 is configured to display the user travel information.

The transmitter 85 is configured to send a service confirmation response to the cloud server according to the user travel information; or provide a travel service to a user according to the user travel information.

The server provided in this embodiment can execute the aforementioned method embodiments, and has similar implementation principles and technical effects. Details of the method embodiments discussed previously will not be repeated herein and are incorporated herein by reference in their entirety.

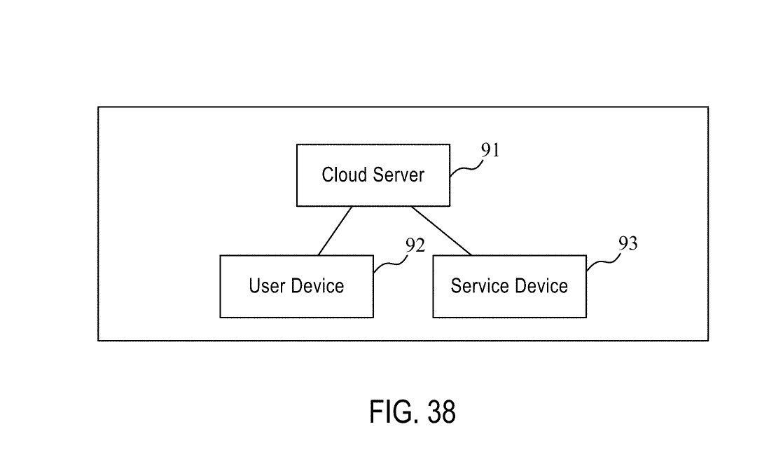

FIG. 38 is a diagram of a system for predicting future travel volumes of geographic regions based on historical transportation network data according to some embodiments of the disclosure.

As shown in FIG. 38, the system for predicting future travel volumes of geographic regions based on historical transportation network data may include a cloud server 91 shown in FIG. 35 above, a user device 92 shown in FIG. 36 above, and a service device 93 shown in FIG. 37 above.

Specifically, the cloud server 91 is separately coupled to the user device 92 and the service device 93, and is configured to predict user travel information in at least one region of a map in a future time range according to first historical travel data, and push the user travel information to at least one service device and at least one user device.

The user device 92 is configured to receive the user travel information in the at least one region in the future time range predicted by the cloud server according to the first historical travel data and display the user travel information, and send a travel request to the service device according to the user travel information.

The service device 93 is configured to receive the user travel information in the at least one region in the future time range predicted by the cloud server according to the first historical travel data and display the user travel information, and provide a travel service to the user device according to the user travel information,

The first historical travel data represents historical travel booking information for different regions of the map, and the user travel information comprises a future travel booking quantity and a future travel booking response quantity in the region within the future time range.

The system for predicting future travel volumes of geographic regions based on historical transportation network data provided in this embodiment can execute the aforementioned method embodiment, and has similar implementation principles and technical effects. Details will not be repeated herein.

A storage medium readable by a computer/processor stores program instructions for making the computer/processor to execute the following steps: predicting user travel information in at least one region of a map in a future time range according to first historical travel data, wherein the first historical travel data represents historical travel booking information for different regions of the map, and the user travel information comprises a future travel booking quantity and a future travel booking response quantity in the region within the future time range; and pushing the user travel information to at least one service device and/or at least one user device.

The readable storage medium may be implemented by any type of volatile or non-volatile storage device or a combination thereof, for example, a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

Finally, it should be noted that the embodiments are only used to describe the technical solutions of the disclosure, rather than limit the technical solutions of the embodiments; although the embodiments are described in detail with reference to the forgoing embodiments, those of ordinary skill in the art should understand that they still can modify the technical solutions disclosed in the forgoing embodiments or equivalently replace part or all of the technical features in the technical solutions; and these modifications or replacements should not make the essences of corresponding technical solutions depart from the scope of the technical solutions of the embodiments.

What is claimed is:

1. A method comprising:
receiving first historical travel data associated with a plurality of users, the first historical travel data including a plurality of first historical travel bookings for a plurality of regions of a map;
predicting user travel information in a selected region of the plurality of regions in a future time range based on the first historical travel data, the user travel information including, within the future time range for the selected region, a future travel booking quantity and a future travel booking response quantity; and
transmitting the user travel information to one of a service device or a user device.

2. The method of claim 1 further comprising:
calculating, based on predicted user travel information associated with each of the plurality of regions within the future time range, a difference between a future travel booking quantity and a future travel booking response quantity in each of the plurality of regions; and
identifying a region having a difference greater than a preset threshold as the selected region.

3. The method of claim 2 further comprising:
performing discretization on geographic location information of the map to obtain one or more grids;
generating second historical travel bookings by adding timestamps to the first historical travel bookings based on a preset time period division policy, wherein a timestamp comprises a date when a first historical travel booking was scheduled and an identifier of a time period during which a first historical travel booking was scheduled, wherein each first historical travel booking includes latitude and longitude information and a time when the corresponding first historical travel booking was scheduled;
generating second historical travel data based on the second historical travel bookings and response information associated with the second historical travel bookings, wherein the second historical travel data comprises at least one third historical travel booking, a third historical travel booking including the second historical travel booking and a response state of the second historical travel booking extracted from the response information; and
mapping the second historical travel data to the one or more grids according to latitude and longitude information of each of the third historical travel bookings in the second historical travel data to obtain the first historical travel data.

4. The method of claim 3, wherein the first historical travel data comprises: a historical travel booking quantity and a historical travel booking response quantity in each of the grids during each time period in a plurality of historical dates; and the user travel information comprises: a future travel booking quantity and a future travel booking response quantity in each of the grids during each time period in a future date.

5. The method of claim 4, wherein the first historical travel data further comprises: a response waiting time and a booking quantity for the first historical travel bookings in each of the grids during each time period in the historical dates, wherein the response waiting time for the first historical travel bookings in each of the grids during each time period in the historical dates specifically comprises: at least one of an average response waiting time, a maximum response waiting time, a median response waiting time, and a minimum response waiting time for the first historical travel bookings in each of the grids during each time period in the historical dates.

6. The method of claim 3, wherein the future time range comprises a current date, and predicting user travel information in a selected region of the plurality of regions in a future time range comprises:
predicting a total travel booking quantity and a total travel booking response quantity for each grid on the current date according to the first historical travel data;
determining a first changing trend of historical travel booking quantities and a second changing trend of historical travel booking response quantities in each grid having different date attributes according to the preset time period division policy, wherein the date attributes comprise any one of a workday attribute, a weekend attribute, and a holiday attribute;
obtaining a travel booking quantity in each of the grids during each time period in the current date according to the total travel booking quantity in each of the grids on the current date and the first changing trend; and
obtaining a travel booking response quantity in each of the grids during each time period in the current date according to the total travel booking response quantity in each of the grids on the current date and the second changing trend.

7. The method of claim 6, wherein predicting a total travel booking quantity and a total travel booking response quantity for each grid on the current date according to the first historical travel data comprises:
building a first time sequence and a second time sequence for each of the grids using the identifier of each grid as a primary key according to the first historical travel data, wherein the first time sequence comprises a total historical travel booking quantity in the grid on the historical dates, the second time sequence comprises a total historical travel booking response quantity in the grid on the historical dates;
predicting the total travel booking quantity for each grid on the current date according to a first ARIMA model and the first time sequence of each of the grids; and
predicting the total travel booking response quantity for each grid on the current date according to a second ARIMA model and the second time sequence of each of the grids.

8. The method of claim 6, wherein determining a first changing trend of historical travel booking quantities and a second changing trend of historical travel booking response quantities in each grid having different date attributes according to the preset time period division policy comprises:
building at least one third time sequence and at least one fourth time sequence for each of the grids using the identifier of each grid and a date dimension as primary keys according to the first historical travel data, wherein the third time sequence comprises historical travel booking quantities during different time periods on the historical dates and the fourth time sequence comprises historical travel booking response quantities during different time periods on the historical dates;
clustering the historical dates in each of the grids according to a preset date attribute to obtain a first attribute date cluster for each of the grids, wherein the first attribute date cluster comprises multiple historical dates meeting the date attribute requirement;
obtaining a first changing trend of historical travel booking quantities in each grid having a date attribute according to all of the third time sequences under the first attribute date cluster; and
obtaining a second changing trend of historical travel booking response quantities in each grid having the date attribute according to all of the fourth time sequences under the first attribute date cluster.

9. The method of claim 3, wherein a first historical travel booking further includes a name and address of a user placing the first historical travel booking.

10. The method of claim 3, wherein the response information comprises a name of a driver responding to a second historical travel booking, latitude and longitude coordinate information of the service device when responding to the second historical travel booking, and a time when responding to the second historical travel booking takes place.

11. An apparatus comprising:
a processor; and
a non-transitory memory storing computer-executable instructions therein that, when executed by the processor, cause the apparatus to perform the operations of:
receiving first historical travel data associated with a plurality of users, the first historical travel data including a plurality of first historical travel bookings for a plurality of regions of a map;
predicting user travel information in a selected region of the plurality of regions in a future time range based on the first historical travel data, the user travel information including, within the future time range for the selected region, a future travel booking quantity and a future travel booking response quantity; and
transmitting the user travel information to one of a service device or a user device.

12. The apparatus of claim 11 wherein the operations further include:
calculating, based on predicted user travel information associated with each of the plurality of regions within the future time range, a difference between a future travel booking quantity and a future travel booking response quantity in each of the plurality of regions; and
identifying a region having a difference greater than a preset threshold as the selected region.

13. The apparatus of claim 12 wherein the operations further include:
performing discretization on geographic location information of the map to obtain one or more grids;
generating second historical travel bookings by adding timestamps to the first historical travel bookings based on a preset time period division policy, wherein a timestamp comprises a date when a first historical travel booking was scheduled and an identifier of a time period during which a first historical travel booking was scheduled, wherein each first historical travel booking includes latitude and longitude information and a time when the corresponding first historical travel booking was scheduled;
generating second historical travel data based on the second historical travel bookings and response information associated with the second historical travel bookings, wherein the second historical travel data comprises at least one third historical travel booking, a third historical travel booking including the second historical travel booking and a response state of the second historical travel booking extracted from the response information; and
mapping the second historical travel data to the one or more grids according to latitude and longitude information of each of the third historical travel bookings in the second historical travel data to obtain the first historical travel data.

14. The apparatus of claim 13, wherein the first historical travel data comprises: a historical travel booking quantity and a historical travel booking response quantity in each of the grids during each time period in a plurality of historical dates; and the user travel information comprises: a future travel booking quantity and a future travel booking response quantity in each of the grids during each time period in a future date.

15. The apparatus of claim 14, wherein the first historical travel data further comprises: a response waiting time and a booking quantity for the first historical travel bookings in each of the grids during each time period in the historical dates, wherein the response waiting time for the first historical travel bookings in each of the grids during each time period in the historical dates specifically comprises: at least one of an average response waiting time, a maximum response waiting time, a median response waiting time, and a minimum response waiting time for the first historical travel bookings in each of the grids during each time period in the historical dates.

16. The apparatus of claim 13, wherein the future time range comprises a current date, and the operations for predicting user travel information in a selected region of the plurality of regions in a future time range further include:
predicting a total travel booking quantity and a total travel booking response quantity for each grid on the current date according to the first historical travel data;
determining a first changing trend of historical travel booking quantities and a second changing trend of historical travel booking response quantities in each grid having different date attributes according to the preset time period division policy, wherein the date attributes comprise any one of a workday attribute, a weekend attribute, and a holiday attribute;
obtaining a travel booking quantity in each of the grids during each time period in the current date according to the total travel booking quantity in each of the grids on the current date and the first changing trend; and
obtaining a travel booking response quantity in each of the grids during each time period in the current date according to the total travel booking response quantity in each of the grids on the current date and the second changing trend.

17. The apparatus of claim 16, wherein the operations for predicting a total travel booking quantity and a total travel booking response quantity for each grid on the current date according to the first historical travel data further include:
building a first time sequence and a second time sequence for each of the grids using the identifier of each grid as a primary key according to the first historical travel data, wherein the first time sequence comprises a total historical travel booking quantity in the grid on the historical dates, the second time sequence comprises a total historical travel booking response quantity in the grid on the historical dates;
predicting the total travel booking quantity for each grid on the current date according to a first ARIMA model and the first time sequence of each of the grids; and
predicting the total travel booking response quantity for each grid on the current date according to a second ARIMA model and the second time sequence of each of the grids.

18. The apparatus of claim 16, wherein the operations for determining a first changing trend of historical travel booking quantities and a second changing trend of historical travel booking response quantities in each grid having different date attributes according to the preset time period division policy further include:
building at least one third time sequence and at least one fourth time sequence for each of the grids using the identifier of each grid and a date dimension as primary keys according to the first historical travel data, wherein the third time sequence comprises historical travel booking quantities during different time periods on the historical dates and the fourth time sequence comprises historical travel booking response quantities during different time periods on the historical dates;
clustering the historical dates in each of the grids according to a preset date attribute to obtain a first attribute date cluster for each of the grids, wherein the first attribute date cluster comprises multiple historical dates meeting the date attribute requirement;
obtaining a first changing trend of historical travel booking quantities in each grid having a date attribute according to all of the third time sequences under the first attribute date cluster; and
obtaining a second changing trend of historical travel booking response quantities in each grid having the date attribute according to all of the fourth time sequences under the first attribute date cluster.

19. The apparatus of claim 13, wherein a first historical travel booking further includes a name and address of a user placing the first historical travel booking.

20. The apparatus of claim 13, wherein the response information comprises a name of a driver responding to a second historical travel booking, latitude and longitude coordinate information of the service device when responding to the second historical travel booking, and a time when responding to the second historical travel booking takes place.
